(19) United States
(12) Patent Application Publication
(10) Pub. No.: US 2020/0080031 A1
(43) Pub. Date: Mar. 12, 2020

(54) MULTI-LAYER CLEANING AND DISINFECTING WIPES HAVING OPTIMAL DELAMINATION BEHAVIOR WITH CLEANING LOTION

(71) Applicant: The Clorox Company, Oakland, CA (US)

(72) Inventors: Nikhil P. Dani, Pleasanton, CA (US); Mark D. Pszczolkowski, Pleasanton, CA (US); Abhishek Kher, Pleasanton, CA (US)

(21) Appl. No.: 16/552,469

(22) Filed: Aug. 27, 2019

Related U.S. Application Data
(60) Provisional application No. 62/727,990, filed on Sep. 6, 2018.

(51) Int. Cl. C11D 17/04; C11D 3/48; C11D 3/20; C11D 3/37; D21H 27/30; D21H 17/36; D21H 17/07; A01N 25/34; A01N 33/12

(52) U.S. Cl. CPC C11D 17/049; C11D 3/48; C11D 3/2068; C11D 3/3753; A01N 33/12; D21H 17/36; D21H 17/07; A01N 25/34; D21H 27/30

(57) ABSTRACT

Pre-moistened multi-layer wipes in which the fibrous substrate for the wipes comprises 70% or more pulp fibers. The present wipes are specifically tailored to include multiple layers that are adhered to one another with a water-resistant adhesive, e.g., which will maintain good peel strength, even when the multi-layer substrate is loaded with a cleaning composition during manufacture, and stored in such condition for an extended period (e.g., a shelf life of a year or more). The water-resistant adhesive may specifically comprise a ethylene vinyl acetate (e.g., rather than polyvinyl alcohol or other adhesives which do not adequately maintain peel strength), loaded between the layers of the substrate, e.g., up to 10 gsm. The wipe may have a peel strength of at least from 0.15 lb_{f}-in, even after being soaked in the cleaning composition. Such pulp substrate wipes are formed from sustainable materials, while providing desired characteristics of strength and efficacy.

### CROSS-REFERENCE TO RELATED APPLICATIONS

This application claims the benefit of and priority to U.S. Provisional Application No. 62/727,990, filed on Sep. 6, 2018. The disclosure is herein incorporated by reference in its entirety.

The present application is related to U.S. Provisional Patent Application No. 62/560,027 filed Sep. 18, 2017, and is also related to U.S. patent application Ser. No. 15/961,663, filed Apr. 24, 2018. The present application is related to each of U.S. Patent application Ser. No. 16/036,095 (CGIG 510.170) filed Jul. 16, 2018; Ser. No. 16/036,688 (CGIG 510.172) filed Jul. 16, 2018; and Ser. No. 16/042,690 (CGIG 510.174) filed Jul. 23, 2018.

### BACKGROUND OF THE INVENTION

### 1. The Field of the Invention

The present invention relates to cleaning wipes, more particularly to pre-moistened cleaning wipes that are formed from multi-layer substrates, where the fibrous substrates are comprised of pulp fibers (e.g., greater than 70% pulp fibers).

### 2. Description of Related Art

Numerous cleaning wipes are available, e.g., such as CLOROX DISINFECTING WIPES. While such wipes provide good overall cleaning and disinfection characteristics, versatility, and convenience, there is a continuing need for improved cleaning wipes.

### BRIEF SUMMARY

The present invention relates to pre-moistened wipes that include a multi-layer substrate comprising two or more layers, each fibrous layer being formed from greater than 70% by weight pulp fibers (e.g., 95% to 100% pulp fibers), where the layers are adhered to one another with a water-resistant adhesive. By forming the substrate layers from pulp, the resulting wipe is more sustainably sourced, while at the same time offering potential improvements in the dosing profile provided by the wipe. For example, many existing wipes based on synthetic fibers tend to quickly dump the cleaning composition loaded therein upon initial wiping or other compression of the wipe, resulting in relatively low “mileage” for a given wipe, as most of the composition is quickly dispensed, so that the wipe becomes relatively dry well before the strength of the wipe itself has been exhausted.

While pulp substrates offer such benefits, it can be difficult to manufacture a single layer wipe having desired characteristics, and use of multiple layers in the substrate provides an interface between the substrate layers which can advantageously serve as a reservoir within which the cleaning composition can be absorbed, and held within the wipe until wiping or other compression causes delivery of the cleaning composition stored therein to be released. That said, it is necessary to adhere such separate layers of a multi-layer substrate to one another, in a manner that does not detract from desired stiffness characteristics of the wipe as a whole, while ensuring that the cleaning composition that is preloaded into the wipe during manufacture does not attack whatever adhesive is used to hold the two or more layers together, which would result in delamination of the two layers from one another during storage.

For example, many adhesives that are available in the art are not readily applied between the initially separate substrate layers in an economical manner (e.g., which is needed for mass production). Other adhesives may be capable of application under such mass production constraints, but do not exhibit good moisture resistance, such that when the multi-layer substrates are pre-loaded with the cleaning composition, the adhesive quickly loses its strength, causing the layers to delaminate from one another well before a consumer has a chance to use the wipe. For example, an appropriate adhesive must exhibit good stability under conditions where the multi-layer substrate is pre-loaded with the cleaning composition during manufacture, and stored in such a moist or wetted condition for weeks or months (e.g., a typical shelf life may be 1 year or more).

The present invention is directed to such multi-layer substrates, loaded with a cleaning composition, where the initially separate layers are held together by a water-resistant adhesive that provides the wipe with a peel strength of at least 0.15 lb_{f}-in, over the shelf life of the wipe (e.g., 1 year or more).

In an embodiment, the water-resistant adhesive comprises an ethylene vinyl acetate adhesive. Ethylene vinyl acetates have been found to be capable of providing the desired peel strength and other characteristics, while many other adhesives known in the art (e.g., polyvinyl alcohols) do not yield acceptable results. Other polyvinyl acetate (PVA) adhesives may also be suitable for use, where they can provide the characteristics described herein.

The cleaning composition may comprise from about 0.05% to about 5% by weight (e.g., 0.1% to 2%) of a quaternary ammonium compound, from about 0.1% to about 5% (e.g., 0.5% to 3%) by weight of a glycol ether, and from about 90% to 99% water.

In an embodiment, the substrate may comprise wood pulp, which may be comprised of generally ribbon-shaped fibers. The substrate may be void of or at least substantially void of synthetic fibers. For example, greater than 70%, at least 75%, at least 80%, at least 85%, at least 90%, or at least 95% of the substrate may comprise pulp fibers. Of the fibers included in the substrate, all or substantially all such fibers may comprise pulp fibers.

The cleaning composition may be pre-loaded into the substrate of the wipe during manufacture, at a loading ratio that is less than saturation, e.g., from 2:1 to 6:1, or from 2:1 to 4:1. Full saturation for such pulp substrates may typically be at a loading ratio of 8:1 or more (i.e., the substrate may be capable of holding at least 8 g of cleaning composition for each gram of substrate weight). As mentioned, the pulp substrate is typically not loaded to full saturation, but may be specifically loaded to a ratio that is less than full saturation, e.g., up to a loading ratio of 6:1, 5:1, 4:1, for example from 2:1 to 4:1, or from 2.5:1 to 3.75:1.

Another embodiment is directed to pre-loaded sanitizing or disinfecting wipe comprising a multi-layer substrate comprising two or more layers, each layer being formed from pulp fibers, wherein the multi-layer substrate is substantially void of synthetic fibers, such that substantially all fibers of the substrate are pulp fibers, the pulp fibers being relatively short (e.g., having an average length of less than 5 mm, such as 1-3 mm), where the two or more layers are adhered to one another with a water-resistant adhesive included in an amount ranging from 2 gsm to 10 gsm, providing the wipe with a peel strength of from 0.15 lb_{f}-in to 0.5 lb_{f}-in. The substrate and water-resistant adhesive collectively (i.e., the wipe in dry form) may provide a basis weight of 35 gsm to 55 gsm, or 40 gsm to 55 gsm, or 50 to 55 gsm. The wipe further includes a cleaning composition pre-loaded into the substrate of the wipe during manufacture that may include, for example, from 0.1% to 2% by weight of a quaternary ammonium compound, and from 90% to 99% water.

The substrate may exhibit pore size distribution and other physical, and performance characteristics as described in Applicant's other applications, already referenced above.

Further features and advantages of the present invention will become apparent to those of ordinary skill in the art in view of the detailed description of preferred embodiments below.

### BRIEF DESCRIPTION OF THE DRAWINGS

To further clarify the above and other advantages and features of the present invention, a more particular description of the invention will be rendered by reference to specific embodiments thereof which are illustrated in the drawings located in the specification. It is appreciated that these drawings depict only typical embodiments of the invention and are therefore not to be considered limiting of its scope. The invention will be described and explained with additional specificity and detail through the use of the accompanying drawings.

FIGS. 1A-1B show photographs of an exemplary wipe substrate formed from pulp fibers.

FIG. 1C is an illustration representing the wipe substrate seen in FIGS. 1A-1B.

FIGS. 2A-2B are SEM images of a pulp substrate such as that of FIG. 1A, showing the generally ribbon-shaped pulp fibers, the localized regions of high fiber density (where fibers appear “matted” together), and the porous structure of the substrate.

FIG. 2C is an SEM image of another pulp substrate that does not include localized regions of high fiber density, in contrast to that of FIGS. 2A-2B.

FIG. 3 schematically illustrates an exemplary process for a roll-coat lamination process by which a multi-layer pulp substrate may be formed.

FIG. 3A illustrates stiffness values for an exemplary pulp substrate at various loading ratios.

FIG. 3B illustrates tensile strength for the same exemplary pulp substrate as in FIG. 3A.

FIG. 4A shows characteristics for retention of cleaning composition loaded within wipe substrates based on various tested substrates, loaded at less than saturation.

FIG. 4B shows retention characteristics for the same substrates as FIG. 4A, loaded to full saturation.

FIG. 4C shows retention of cleaning composition for the same substrates as FIG. 4A, tested according to two different wiping regimes.

FIG. 5 shows an exemplary wipes dispensing system in which the container is configured as a flex pack.

FIG. 6 shows an exemplary wipes dispensing system in which the container is configured as a cylinder, in which the wipes are configured as a donut that is received into the cylinder.

FIG. 7 shows an exemplary wipes dispensing system in which the container is configured as a generally rectangular tub.

### DETAILED DESCRIPTION OF THE PREFERRED EMBODIMENTS

### Definitions

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

The term “comprising” which is synonymous with “including,” “containing,” or “characterized by,” is inclusive or open-ended and does not exclude additional, unrecited elements or method steps.

The term “consisting essentially of” limits the scope of a claim to the specified materials or steps “and those that do not materially affect the basic and novel characteristic(s)” of the claimed invention.

The term “consisting of” as used herein, excludes any element, step, or ingredient not specified in the claim.

It must be noted that, as used in this specification and the appended claims, the singular forms “a,” “an” and “the” include plural referents unless the content clearly dictates otherwise. Thus, for example, reference to a “surfactant” includes one, two or more surfactants.

Unless otherwise stated, all percentages, ratios, parts, and amounts used and described herein are by weight.

Numbers, percentages, ratios, or other values stated herein may include that value, and also other values that are about or approximately the stated value, as would be appreciated by one of ordinary skill in the art. As such, all values herein are understood to be modified by the term “about”. A stated value should therefore be interpreted broadly enough to encompass values that are at least close enough to the stated value to perform a desired function or achieve a desired result, and/or values that round to the stated value. The stated values include at least the variation to be expected in a typical manufacturing process, and may include values that are within 10%, within 5%, within 1%, etc. of a stated value. Furthermore, where used, the terms “substantially”, “similarly”, “about” or “approximately” represent an amount or state close to the stated amount or state that still performs a desired function or achieves a desired result. For example, the term “substantially” “about” or “approximately” may refer to an amount that is within 10% of, within 5% of, or within 1% of, a stated amount or value.

Some ranges may be disclosed herein. Additional ranges may be defined between any values disclosed herein as being exemplary of a particular parameter. All such ranges are contemplated and within the scope of the present disclosure.

In the application, effective amounts are generally those amounts listed as the ranges or levels of ingredients in the descriptions, which follow hereto. Unless otherwise stated, amounts listed in percentage (“%′s”) are in weight percent (based on 100% active) of any composition.

The phrase ‘free of’ or similar phrases if used herein means that the composition or article comprises 0% of the stated component, that is, the component has not been intentionally added. However, it will be appreciated that such components may incidentally form thereafter, under some circumstances, or such component may be incidentally present, e.g., as an incidental contaminant.

The phrase ‘substantially free of’ or similar phrases as used herein means that the composition or article preferably comprises 0% of the stated component, although it will be appreciated that very small concentrations may possibly be present, e.g., through incidental formation, contamination, or even by intentional addition. Such components may be present, if at all, in amounts of less than 1%, less than 0.5%, less than 0.25%, less than 0.1%, less than 0.05%, less than 0.01%, less than 0.005%, less than 0.001%, or less than 0.0001%. In some embodiments, the compositions or articles described herein may be free or substantially free from any specific components not mentioned within this specification.

As used herein, “disposable” is used in its ordinary sense to mean an article that is disposed or discarded after a limited number of usage events, preferably less than 25, more preferably less than about 10, and most preferably after a single usage event. The wipes disclosed herein are typically disposable.

As used herein, the term “substrate” is intended to include any material that is used to clean an article or a surface. Examples of cleaning substrates include, but are not limited to, wipes, mitts, pads, or a single sheet of material which is used to clean a surface by hand or a sheet of material which can be attached to a cleaning implement, such as a floor mop, handle, or a hand held cleaning tool, such as a toilet cleaning device. The term “substrate” is also intended to include any material that is used for personal cleansing applications. These substrates can be used for hard surface, soft surface, and personal care applications. Such substrates may typically be in the form of a wipe.

Such substrates may be formed of a structure of individual fibers which are interlaid, typically in a manner that is not identifiable, similar to a nonwoven. The pulp substrates may be formed by any suitable process, typically through wetlaying, although airlaying may also be possible. The fibers of the substrate may generally be ribbon-shaped, rather than the generally circular fiber geometry of synthetic fibers commonly used in synthetic nonwovens. The basis weight of the pulp or tissue substrate may be expressed in grams per square meter (gsm). Basis weight of such substrates is sometimes also expressed in “pounds” (e.g., referring to lbs/3000 ft² of the tissue paper).

The terms “wipe”, “substrate” and the like may thus overlap in meaning, and while “wipe” may typically be used herein for convenience, it will be appreciated that this term may often be interchangeable with “substrate”.

As used herein, “wiping” refers to any shearing action that the wipe undergoes while in contact with a target surface. This includes hand or body motion, substrate-implement motion over a surface, or any perturbation of the substrate via energy sources such as ultrasound, mechanical vibration, electromagnetism, and so forth.

The cleaning compositions dosed onto the substrate as described herein may provide sanitization, disinfection, or sterilization. As used herein, the term “sanitize” shall mean the reduction of “target” contaminants in the inanimate environment to levels considered safe according to public health ordinance, or that reduces a “target” bacterial population by significant numbers where public health requirements have not been established. By way of example, an at least 99% reduction in bacterial population within a 24 hour time period is deemed “significant.” Greater levels of reduction (e.g., 99.9%, 99.99%, etc.) are possible, as are faster treatment times (e.g., within 10 minutes, within 5 minutes, within 3 minutes, within 2 minutes, or within 1 minute), when sanitizing. As used herein, the term “disinfect” shall mean the elimination of many or all “target” pathogenic microorganisms on surfaces with the exception of bacterial endospores. As used herein, the term “sterilize” shall mean the complete elimination or destruction of all forms of “target” microbial life and which is authorized under the applicable regulatory laws to make legal claims as a “sterilant” or to have sterilizing properties or qualities. Some embodiments may provide for at least a 2 or more log reduction in a bacterial population within a designated time period (e.g., 10 minutes, 5 minutes, 3 minutes, 1 minute, 30 seconds, 10 seconds or the like). A 2-log reduction is equivalent to a 99% reduction, a 3-log reduction is equivalent to at least a 99.9% reduction, a 4-log reduction is equivalent to at least a 99.99% reduction, a 5-log reduction is equivalent to at least a 99.999% reduction, etc. An example of a target microbe may be Staphylococcus aureus. It will be appreciated that microefficacy can also be achieved against other target microbes, numerous examples of which will be apparent to those of skill in the art. It will also be appreciated that the present cleaning compositions need not include an antimicrobial agent, where sanitization or disinfection is not necessarily desired.

The term “texture” as used herein refers to the character or appearance of a substrate as determined by the arrangement and thickness of its constituent fibers. Texture can be quantified using imaging techniques and/or caliper measurements at the local and macro scales, as described herein.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

II. Introduction

In an aspect, the present invention is directed to pre-moistened wipes that include a multi-layer substrate, where each layer comprises greater than 70% by weight of pulp fibers. The two or more layers of the substrate are adhered to one another with a water-resistant adhesive, that provides a peel strength under such pre-moistened wet conditions of at least 0.15 lb_{f}-in. The substrate is dosed with a cleaning composition at the time of manufacture. The composition may typically include a majority of water, as well as various other components, such as a quaternary ammonium compound, a solvent or cosolvent (e.g., a glycol ether), as well as various other optional adjuvants.

By including two initially separate pulp substrate layers, an interface is provided between such layers, which interface can increase the absorption capacity of the resulting substrate, as compared to a single layer substrate of otherwise similar characteristics (e.g., similar density, thickness, fiber lengths, etc.). The difficulty of including two such initially separate layers lies though in how to adhere the two layers to one another, in a manner that the layers will not easily delaminate from one another during storage while soaked in the cleaning composition, or prior to use. For example, while two-ply paper towels exist, the two plies are not bonded to one another in a manner that the bonding is resistant to water. For example, upon contact with water, the two plies of such paper towels quickly delaminate from one another, such that the bond between the layers exhibits negligible peel strength.

In addition, multi-layer pre-moistened wipes currently available are made using technologies such as hydroentangling or thermal calendaring that are not suitable for use with the pulp substrates as contemplated herein. For example, in hydroentangling the fibers are reoriented from a generally horizontal to a generally vertical orientation “into” the thickness of the nonwoven substrate by high pressure water jets. Such hydroentangling can work with relatively long synthetic fibers, but does not work with the relatively short pulp fibers (e.g., 1-3 mm typical) as contemplated herein. In thermal calendaring, the fibers are locally melted to create bond points, giving the overall nonwoven structure greater strength and integrity. Because pulp fibers are not thermoplastic, such a technique cannot be used with pulp fibers as contemplated herein.

Furthermore, while paper towels are sometimes formed with two plies “glued” to one another using a very low viscosity solution of polyvinyl alcohol, such adhesives as currently used for this purpose are not suitable for use where the pulp substrate is going to be dosed with an aqueous cleaning composition and stored in such a pre-moistened condition for a significant period of time (e.g., a shelf life of 1 year or more). Under such conditions, the adhesives sometimes used in paper towel manufacturing exhibit negligible peel strength (e.g., less than 0.05 lb_{f}-in), making them unsuitable for use.

In addition to the need to ensure sufficient peel strength, because the wipe is pre-loaded with a cleaning composition, it is important to ensure compatibility between any particular adhesive used to adhere the initially separate layers together, and the components of the cleaning composition. For example in addition to not disintegrating under aqueous conditions, any selected adhesive must not react with the quaternary ammonium compound, or other components included in the cleaning composition. Such requirements complicate the design and narrow the range of suitable materials that can be used in providing such a wipe.

The present invention uses an ethylene vinyl acetate or other water-resistant adhesive, which has been found by Applicant to provide the desired peel strength characteristics. In addition to particular characteristics relating to the adhesive and the multi-ply structure, the substrate may also include one or more characteristics that Applicant has found to correlate to other desirable properties, such as high durability, mileage, cleaning composition retention, micro-efficacy, or the like.

III. Exemplary Wipes

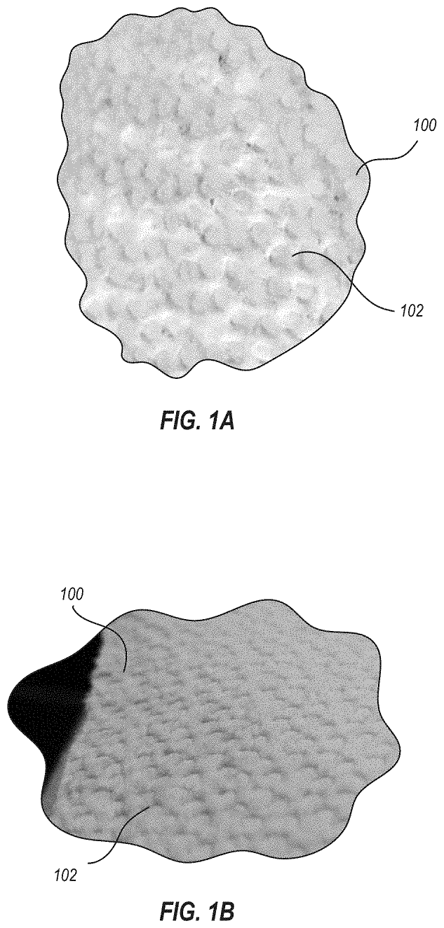

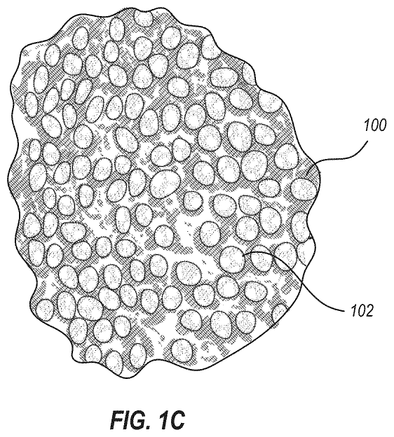

FIG. 1A illustrates an exemplary wipe including a multi-layer substrate that may be dosed with a cleaning composition. The wipe may include a texture, as shown, or may not include such a texture. The illustrated substrate 100 includes regions of localized high fiber density, resulting in the illustrated texture. Such regions create the appearance on a macro-scale of a texture, including raised ridges 102, as shown. Such texture may be permanent, e.g., having been introduced into the substrate structure as a result of the geometry used in the forming screen used when depositing the pulp fibers that make up the substrate, as opposed to an embossing procedure which merely embosses a raised texture into an already formed substrate after wet-laying or air-laying. Such post-formation embossed textures are typically not permanent, but are removed from the substrate upon wetting. The presently described permanent texture of raised ridges 102 as shown is permanent, meaning that this structural feature is retained even upon wetting (and any subsequent redrying). As mentioned, such texture is optional.

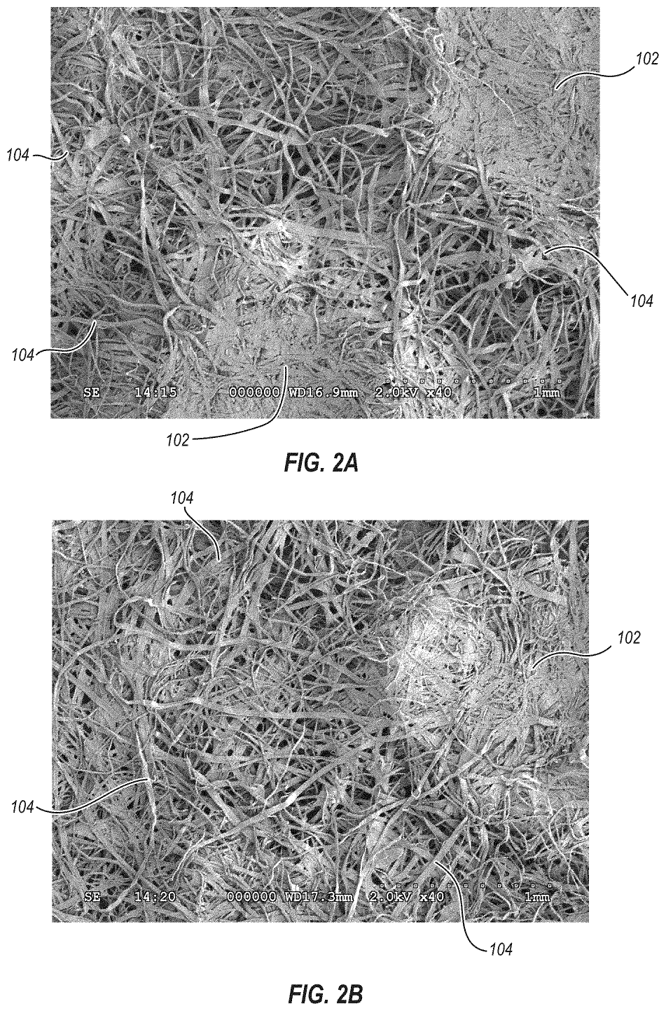

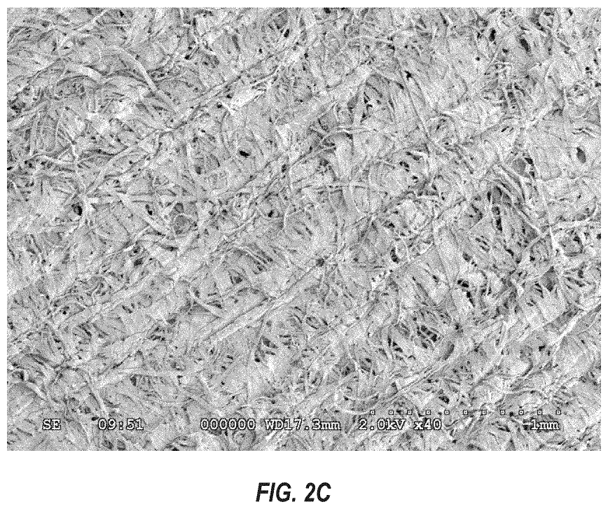

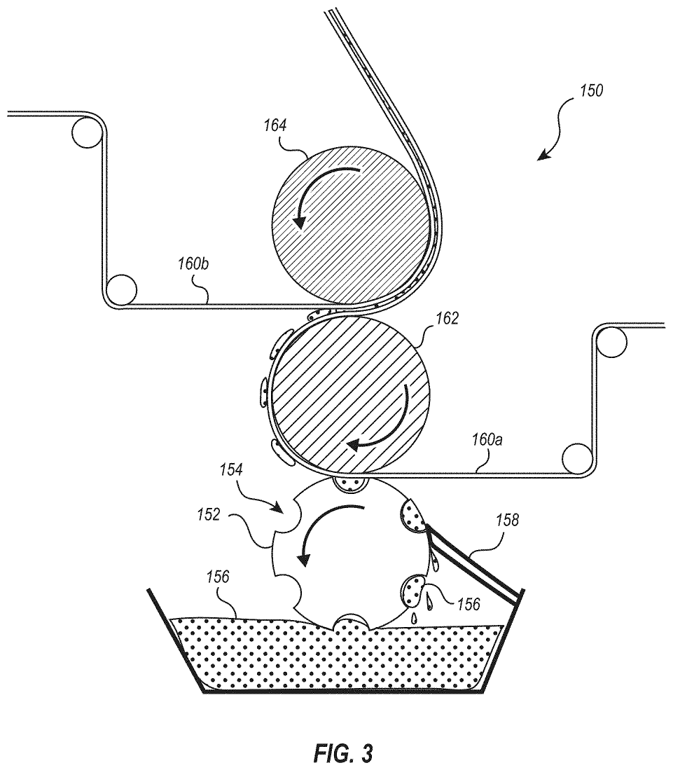

FIGS. 2A-2B show SEM images of the substrate seen in FIG. 1A, clearly showing the generally ribbon shape of the individual pulp fibers 104 of the substrate 100, as well as the localized regions of high fiber density 102, where masses of the generally ribbon-shaped fibers 104 appear to be matted together. As noted above, such regions 102 of localized high fiber density providing the textured appearance seen in FIG. 1A are formed during depositing of the pulp fibers, through selection of an appropriate screen geometry, which allows such regions of localized high fiber density to be deposited during wet-laying or air-laying. Such a screen may include high and low regions, so that the lower recessed regions and higher protruding regions may receive differing densities or thicknesses of pulp fibers, resulting in the permanent texture that is retained even upon wetting.

a. Pulp Characteristics

The fibrous portion of the multi-layer substrates are formed predominantly, and preferably entirely, from pulp fibers, e.g., wood pulp or other plant fibers. Each of the multiple layers may be so formed (e.g., rather than a configuration with a synthetic layer, and an adjacent pulp layer). While the substrate as a whole and each individual layer of the multi-layer substrate may generally comprise greater than 70% by weight of pulp fibers, in an embodiment, at least 75%, at least 80%, at least 85%, at least 90%, at least 95%, at least 97%, at least 98%, or at least 99% of the fibers are pulp fibers. In an embodiment, all fibrous layers of the multi-layer substrate consist of or consist essentially of pulp fibers. In addition to the pulp fiber layers of the substrate, the only other component of the dry substrate (absent the cleaning composition) may be the water-resistant adhesive.

Such pulp fibers may typically be obtained from wood, although other possible sources of pulp are also possible, e.g., from cotton, Esparto grass, bagasse, hemp, flax, jute or the like. Combinations of more than one material may be used. Various exemplary pulp fibers may include, but are not limited to, thermomechanical pulp fibers, chemimechanical pulp fibers, chemithermomechanical pulp fibers, refiner mechanical pulp fibers, stone ground wood pulp fibers, peroxide mechanical pulp fibers, and the like. The fibers of the pulp substrate may generally comprise cellulosic fibers, which are typically hydrophilic. Such hydrophilicity differs from many synthetic fibers, which are typically hydrophobic, absent special treatment.

In one embodiment, the pulp fibers are selected from softwood and hardwood varietals, including but not limited to, Maple, Ash, Hard Pine, Spruce, Hemlock, Fir, White Pine, Red Pine, Eucalyptus, Populus spp. Birch, Basswood, Beech, Redgum, Cherry, Hornbeam, Yellow-Poplar, Douglas-Fir, and other suitable varietals of wood. Typically the pulp substrates have a mixture of fibers selected from the group consisting of: hardwood, softwood, bleached fibers and kraft fibers and any combinations or mixtures thereof. The type of fibers and mixture of the fibers within a substrate can have a significant impact on its performance not just with respect to softness or absorbency, but also with respect to dosing and release of a quaternary ammonium compound from the substrate. Specifically, substrates with a high percentage of fibers, e.g., greater than 50% by weight, that come from bleached pulp fibers with a weighted length L_{(w)} between 1 mm to 5 mm, or 1 mm to 4 mm, more preferably between 2 mm and 3 mm, correlate with substrates having superior performance for cleaning applications and quat release (e.g greater than 25%, or greater than 30% release by weight, etc.). Pulp substrates having a weighted length L_{(w)} of less than 1 mm, or even less than 2 mm, may exhibit inferior quat release. In addition, as described herein, such short fibers (e.g., less than 5 mm) are not well suited for hydroentangling or various other methods of adhering initially separate layers to one another.

By way of further description, softwood fibers, such as various species of evergreens (e.g., spruce, hemlock, firs, pines, etc), may typically provide for the desirable longer fiber lengths (e.g., L(w) greater than 2 mm, such as values between 2.1 mm and 3 mm). Hardwood fibers, such as various species of maple, eucalyptus, ash, populous spp., birch, basswood, beech, redgum, cherry, hornbeam, yellow-poplar, and other hardwoods typically provide shorter fiber lengths, e.g., less than 2 mm, more typically less than 1 mm. While it may be desirable to include some shorter length and/or hardwood fibers in the blend of the pulp employed, the fraction of such shorter length fibers and/or hardwood fibers may be limited to less than 50%, less than 45%, less than 40%, or less than 35% by weight of the pulp blend. For example, Applicant has found that such shorter length fibers tend to exhibit greater anionic charge, so as to exhibit a greater tendency to interfere with the desired quat release. In addition, such shorter length fibers may close up the substrate, reducing permeability and porosity, negatively impacting pore characteristics as described herein. Similarly, the fraction of the longer length fibers and/or softwood fibers may be at least 50%, at least 55%, at least 60%, or at least 65%. The pulp may have an average fiber length (e.g., a weighted length L_{(w)}) that is less than 5 mm, or less than 4 mm, but greater than 1 mm, such as from 1 mm to 3 mm, or 2 mm to 3 mm.

Another characteristic that may be used to characterize the pulp fibers contemplated herein is the number of fibers per gram, which is typically reported in millions of fibers per gram. For example, the softwood, longer length pulp fibers may have values that are less than 10 million fibers/g, less than 8 million fibers/g, less than 6 million fibers/g, or less than 5 million fibers/g. Such pulp fibers may also have fibers that are at least 1 million fibers/g, or at least 2 million fibers/g (e.g., from 1 to 6, or from 2 to 5 million fibers/g.). In contrast, the hardwood, shorter length pulp fibers typically have values that are far higher, such as more than 10 million fibers/g, more than 12 million fibers/g, more than 15 million fibers/g. For example, exemplary softwood kraft pulp may have an L_{(w)} value of about 2.2, and a population value of about 4.5 million fibers/g. Another exemplary softwood kraft pulp may have an L_{(w)} value of about 2.5, and a population value of about 2.4 million fibers/g. In contrast, an exemplary maple hardwood pulp may have an L_{(w)} value of about 0.6, and a population value of about 27.6 million fibers/g. An exemplary eucalyptus hardwood pulp may have an L_{(w)} value of about 0.8, and a population value of about 19.8 million fibers/g.

Each layer of the multi-layer substrate may have a basis weight of no more than 50 lbs, no more than 40 lbs, no more than 30 lbs, or no more than 20 lbs, at least 3 lbs, at least 5 lbs, or at least 10 lbs, such as from 10 lbs to 20 lbs. Such “lbs” values refer to the weight per/3000 ft², as will be appreciated by those of skill in the art.

Preferably, the substrate includes only limited amounts, or does not include any added synthetic fibers, e.g., such as various polyolefins or other fibers formed from synthetic polymers, e.g., polyethylene, polypropylene, PET, PVC, polyacrylics, polyvinyl acetates, polyvinyl alcohols, polyamides, polystyrenes, or the like. While such synthetic fibers are widely used in the manufacture of nonwoven substrates, Applicant has discovered that the use of a pulp substrate, in combination with the various other characteristics described herein, allows production of a wipe which can provide functional advantages over synthetic nonwoven wipes, and which may also be consumer preferred, or at least comparable, for consumer perceptions of durability, safe for use on all surfaces, ease and convenience, ability to clean and absorb light liquid spills, and ability to clean large areas effectively. Furthermore, the use of synthetic nonwoven substrates in existing pre-moistened wipes represents a significant expense, such that cost savings, renewability and sustainability benefits, and biodegradability benefits can be achieved using pulp substrates, as described herein.

The individual layers of the multi-layer pulp substrate can be formed by a number of different techniques, e.g., such as any of those suitable for use in forming paper towels. Examples include, but are not limited to wet-laying and air-laying techniques. Methods of making such substrate layers will be apparent to those of skill in the art. Wet-laying processes are described in U.S. Pat. Nos. 5,246,772 and 5,238,534 to Manning. Air-laying processes are described in U.S. Patent Publication No. 2003/0036741 to Abba et al. and U.S. Patent Publication No. 2003/0118825 to Melius et al. Such processes will be familiar to those of skill in the art, in light of the present disclosure.

In an embodiment, the multi-layer substrate may include a texture as seen in FIGS. 1A-1C. Such a texture may include high fiber density regions as described herein, which regions may be characterized by lower air permeability or porosity as compared to the surrounding regions. That said, measurement of the mass of such tiny regions (e.g., typically length and/or width of less than 1 mm) is not practical, nor is measurement of air permeability of such small regions using a Frazier air permeability tester, or the like. SEM imaging of such substrates though is readily practical, and can be used to indirectly measure air permeability, porosity and/or fiber density characteristics. For example, such an image analysis technique may include analyzing a gray scale image with software such as ImageJ. ImageJ is a public domain image processing tool developed by National Institutes of Health (NIH).

Such a method of image analysis may include loading the gray scale image of the substrate into ImageJ, and selecting visibly differentiated high and low density regions using the selection tool. Using the rectangular selection tool, the size may be set to 250×250 pixels, for example. The ImageJ tool “Plot profile analysis” can be run on the selected regions, which reports a median gray value (between 0 and 255) for the particular selection. In such scale, the “0” value corresponds to full black, while the “255” value corresponds to full “white”, and all values in between correspond to various shades of gray within the 8-bit resolution. High fiber density regions exhibit gray scale values under such analysis that are lighter in color (i.e., towards “255”), while the surrounding lower fiber density regions exhibit gray scale values under such analysis that are darker in color (i.e., towards “0”).

By way of further example, analysis of Figures such as 2A and 2B may produce a gray scale median value of “134” for the high fiber density regions, while the surrounding lower fiber density regions may produce a gray scale median value of “104”. In general, the high fiber density regions may be at least 20 value points greater, or at least 25 value points greater than the surrounding lower fiber density regions when compared by such an analysis on an 8-bit gray scale. Even if the SEM image were obtained under different conditions, while the absolute average gray scale values may differ, the high fiber density regions would still have a relatively higher gray scale value as compared to the surrounding lower fiber density regions, and the actual point value of such difference may still be more than 20 points on an 8-bit scale. For comparison, FIG. 2C illustrates an SEM image of another substrate, which does not include such regions of relatively higher fiber density. Some embodiments may not include such texturing, as in FIG. 2C.

b. Multi-Ply Pulp Substrates

The pulp substrate specifically comprises two or more plies that have been laminated or otherwise adhered together, so as to have adequate peel strength (e.g., at least 0.15 lb_{f}-in). Because the pulp substrate will be dosed during manufacture with a cleaning composition, and stored for long periods of time in such wetted condition, it is important that the structure of the multi-ply configuration remain stable, without separating, for an extended period of time (e.g., 12 months or more). Such requirements differ from typical paper towel of other tissue materials (e.g., bath tissue) that may be formed of two or more plies, although some similarities in the process of manufacture may exist. One method for adhering the two tissue plies may involve roll coating, in which the tissue layers, which may include an embossed texture of peaks and valleys, are passed over a drum or cylinder that applies a low viscosity adhesive coating onto the peaks of the tissue layer, as the peaks contact the drum or cylinder. The tissue layers are then laminated together as they pass through a nip between two rollers, effectively gluing the two tissue layers together. It will be apparent that such a method may result in a discontinuous water-resistant adhesive layer between the two tissue layers, because the adhesive may only be added to the peaks of the tissue layer.

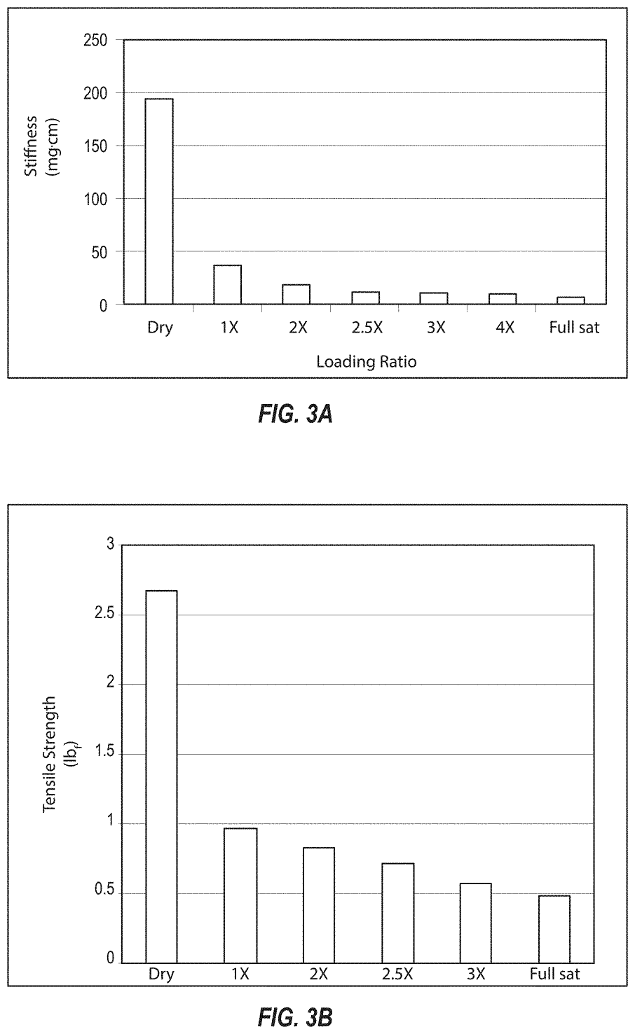

As shown in FIG. 3, a particular roll coated lamination method and system 150 may involve a gravure or anilox roller 152, in which reservoirs 154 on the roller 152 are filled by an adhesive supply 156. Excess adhesive may be removed by a blade 158 such that only the reservoirs 154 are filled. During coating, the adhesive in the reservoirs 154 comes in contact with the first pulp tissue layer 160a, applying the adhesive 156 either in a discontinuous or continuous pattern to one entire layer (160a) before lamination of the first tissue layer 160a to a second tissue layer 160b via a nip. The illustrated configuration includes a transfer roller 162 and a nip roller 164, which serve to glue the two tissue layers 160a, 160b to one another. The transfer roller 162 may be formed of medium to high durometer rubber, while the nip roller 164 may be steel. Such difference in materials aids to ensure uniform pressure is applied, in order to achieve good lamination or adhesion. The particular continuous or discontinuous pattern of adhesive application may depend on the particular pattern of the reservoirs 154, in roller 152. Additional details of an embossing lamination roll-coat process are disclosed in U.S. Pat. No. 6,086,715, incorporated herein by reference in its entirety. Other methods of adhesive application to a tissue layer may include but are not limited to hydraulic sprays, air atomized sprays, continuous and discontinuous slot die coat applications, as well as other processes that will be apparent to those of skill in the art, in light of the present disclosure.

The adhesives used herein to achieve a water-resistant adhesion, with adequate peel strength are different than those adhesives typically used in paper towel and bath tissue manufacture. That said, the adhesive used must still be easy to apply, widely available, and must be applied at sufficiently low levels to prevent the final product from feeling too “stiff”, which would be unacceptable. While a very dilute solution of water soluble polyvinyl alcohol (PVOH) is often used as the adhesive in manufacturing paper towels and bath tissue, this adhesive is not suitable for the pre-moistened wipes as contemplated herein, even if the application rate of such adhesive were increased. PVOH is simply not able to provide a sufficiently high peel strength, even at higher application rates or basis weights. For example, even at a very high adhesive loading such as 5 gsm between two such plies, the resulting wipe continues to exhibit a peel strength of less than 0.15 lb_{f}-in, and at this high loading of PVOH, the stiffness and “hand feel” of the resulting wipe may be negatively affected.

A suitable adhesive for the contemplated application will have several key requirements, as described herein. Once cured, the adhesive needs to have solubility resistance to water, other solvents and other chemicals typically found in disinfecting lotions such as those described herein. Additionally, the adhesive needs to exhibit good bond strength to high pulp or cellulose containing structure tissue structures, as described herein. Additionally, the adhesive needs to have properties that are conducive to it being used in a mass-manufacturing environment. Such properties include having a workable, sufficiently low viscosity, set times that are long enough to not cause it to dry on application equipment when being applied, and others that will be appreciated by those of skill in the art. Partially hydrolyzed and fully hydrolyzed PVOH-based adhesives, even with the use of cross-linkers (e.g., such as borax or others), are not acceptable because at reasonable adhesive loadings they fail to maintain good bond strength when exposed to the cleaning composition.

For example, a reasonable adhesive loading may be less than 75 gsm of adhesive loading in lab-scale testing environments. More typical adhesive loadings as described herein are less than 10 gsm, such as 3-5 gsm, or 3-4 gsm. Ethylene vinyl acetate (EVA) water-based adhesive emulsions were tested with some success. To achieve reasonable bonding, the dry solids content of the adhesive emulsion is generally greater than or equal to 50% dry solids content. For example, solids content may be greater than 50%, greater than 52%, greater than 55%, greater than 56%, up to 90%, up to 85%, up to 80%, up to 75%, up to 70%, such as from 50 to 90%, from 50% to 85%, or from 55% to 70%.

For example EVA materials below 50% dry solids content may not be successful in retaining sufficient lamination peel strength when exposed to the cleaning lotion. Several EVA adhesives may meet this requirement, but may not have physical properties suitable for running on roll-coat processing methods such as seen in FIG. 3. To be suitable for such processing, a viscosity equal to or less than 500 cps is desirable. Several adhesives of proprietary or otherwise unknown chemistries and/or dry solids content were discarded because although they had reasonable lamination strength, their viscosity was greater than 1000 cps. It is also worth noting that hot-melt type adhesives were also considered, but they may often form a hard plastic spot on the wipe upon setting, creating an undesirable hand feel. Upon setting, particularly preferred EVA adhesives may exhibit some elasticity or elongation, similar to a rubber or gel which does not hamper the consumer experience. Other vinyl acetate adhesives (e.g., polyvinyl acetate (“PVA”)) may also be suitable for use, where they can provide the characteristics described herein. Examples of tested adhesive materials are shown below in Tables 1A-1B.

Because the present wipes are not typically intended for food contact (e.g., paper towels are often used as a substitute for a napkin or plate, on which to place a sandwich or the like), it is not necessary that the components used in the present wipe necessarily meet FDA GRAS requirements. In addition, while stiffness of the wetted substrate is an important consideration, the stiffness of the dry substrate is not a primary concern (as it is in paper towel and bath tissue production). Of paramount concern is that the adhesive not delaminate when such a multi-ply substrate is loaded with the cleaning composition over the typical shelf life of the pre-moistened wipe (e.g., at least 12 months). In addition, the wipe must be stable and remain efficacious (e.g., antimicrobial efficacy for a sanitizing or disinfecting wipe) in the dosed configuration for at the shelf life (e.g., at least 12 months).

Ethylene vinyl acetate emulsions are an example of a suitable water-resistant adhesive, particularly where the dry solids content is greater than 50% by weight. Various adhesives that were tried by Applicant, and found to be unsuitable include at least some EVA emulsions with dry solids content less than 50%, partially hydrolyzed PVOH, fully hydrolyzed PVOH, cross-linked PVOH, and adhesives with viscosities greater than 1000 cps.

The weight basis or loading of adhesive added to permanently bond the two tissue layers together may be greater than typically employed in paper towel manufacturing. For example, adhesive loading may be up to 10 gsm, such as from 1 gsm to 10 gsm, from 2 gsm to 8 gsm, or from 3 gsm to 6 gsm. The substrate and water resistant adhesive together may collectively have a basis weight of at least 35 gsm, such as 35 to 55 gsm, or 40 to 55 gsm. Such basis is greater than is typical of other paper product manufacturing processes. Stated another way, the adhesive loading may be at least 3%, at least 4%, at least 5%, from 3% to 20%, from 3% to 15%, from 3% to 10%, or from 5% to 10% of the dry substrate (i.e., pulp plus adhesive), by weight. To little adhesive results in peel strength values that are unacceptable, while too much adhesive makes the resulting substrates too stiff, negatively affecting hand feel and other important wipe characteristics.

The adhesive solution may have a relatively low viscosity, but still somewhat higher than that of water (i.e., 1 cps). For example, the adhesive solution as applied may have a viscosity of less than 1000 cps, less than 500 cps, greater than 10 cps, greater than 50 cps, greater than 100 cps, or greater than 200 cps, such as from 250 cps to 450 cps.

Because of the particular selection of the type of adhesive, and how much adhesive is applied, the wipes are able to provide good peel strength characteristics, holding the two plies together during storage after manufacture, up until use, and throughout the useful life of the wipes. Peel strength may be at least 0.15 lb_{f}-in, such as from 0.15 lb_{f}-in to 0.50 lb_{f}-in, or from 0.2 lb_{f}-in to 0.3 lb_{f}-in. Such values are for the “mean area under the curve”, representing the total work required to separate two adjacent layers of the substrate from one another. Various peel strength tests will be known to those of skill in the art, any of which may be suitable for use herein. By way of example, the layers may be pulled apart at a pull-apart angle of 45°, 90°, 180°, or the like. Various exemplary test standards may be found under, but not limited to ASTM D903, ASTM D1876, ASTM D3330, and the like.

Table 1A shows exemplary and comparative multi-layer substrates, loaded to various loading ratios, with different adhesives, at varying adhesive loading values, and the resulting peel strengths, reported as mean area under the curve (i.e., average work required to pull the two plies apart).

TABLE 1A

| | | | Adhesive | Mean Area | Relative |
|---|---|---|---|---|---|
| | Loading | | Loading | Under Curve | Peel |
| Sample | Ratio | Adhesive | (gsm) | (lb_{f}-in) | Strength |
| 1 (control) | 3.25:1 | None | N/A | 0.048 ± 0.001 | 1 |
| 2 | 3.25:1 | EVA | 4.54 | 0.275 ± 0.01 | 5.681 |
| 3 | 3.25:1 | EVA | 3.12 | 0.208 ± 0.013 | 4.290 |
| 4 | 3.25:1 | PVOH | 2.5 | 0.117 ± 0.004 | 2.413 |
| 5 | 3.25:1 | PVOH | 5 | 0.127 ± 0.001 | 2.619 |
| 6 (control) | 1:1 | None | N/A | 0.040 ± 0.002 | 1 |
| 7 | 1:1 | PVOH | N/A | 0.044 ± 0.001 | 1.100 |
| 8 | 3.25:1 | PVOH | N/A | 0.047 ± 0.003 | 1.175 |
| 9 | 3.25:1 | PVOH | N/A | 0.074 ± 0.000 | 1.850 |
| 10 | 3.25:1 | PVOH | N/A | 0.065 ± 0.002 | 1.625 |

Samples 1-6 included the same tissue layers in their 2-ply substrates. For example, each of pulp tissue layers exhibited as basis weight of 16 lbs. All samples were loaded with the same exemplary cleaning composition, with control sample 6 and sample 7 being at a loading ratio of 1:1, while the others were loaded at 3.25:1. The reported relative peel strengths for samples 2-5 are relative to control #1, while the reported relative peel strengths for samples 7-10 are relative to control #6. PVOH and EVA adhesives were tested, both sprayed on for this particular test. Even at a high loading (sample 5), the PVOH adhesive was unable to provide a sufficiently high peel strength. For example, the increase in peel strength between sample 4 (at an adhesive loading of 2.5 gsm) to sample 5 (at an adhesive loading of 5 gsm) is less than 10%, with a doubling of the adhesive loading. For this reason, PVOH is not a particularly suitable adhesive.

The EVA of samples 2 and 3 provided good results, with a peel strength greater than 0.15 lb_{f}-in, and even greater than 0.2 lb_{f}-in. In samples 2 and 3 the weight basis of the adhesive was from 3 to 4 gsm. In addition, the stiffness characteristics of the overall wipe in samples 2 and 3 were not negatively impacted by the presence of the EVA adhesive at these loading values. Samples 7-10 were commercially available two-ply paper towels that were soaked in the lotion at the noted loading ratios. As shown, these are adhered with a PVOH adhesive, and these samples exhibited peel strength values far lower than 0.15 lb_{f}-in. In particular, the peel strengths of samples 7-10 were similar or only slightly higher than the control sample 1, which included no adhesive at all. Only samples 2 and 3 exhibited sufficient peel strength values.

As compared to typical paper towel manufacture, the present wipes do not necessarily need to be able to absorb large volumes of aqueous spills, and can have much higher amounts of adhesive as compared to existing paper towel products. The present wipes are pre-dosed, during manufacture, and are not intended to be so absorbent, for cleaning-up spills. Any minor decrease in absorbency caused by the presence of the relatively large quantity of adhesive is acceptable within the present substrates, as massive absorbency is not critically important. An additional benefit of using such a higher level of adhesive is that this may reduce or minimize exposure of binding sites on the anionic pulp substrate that might otherwise bind the cationic biocide (e.g. quaternary ammonium, biguanide) included in the cleaning composition. This may enable improved delivery of the cationic biocide to the surface being treated. An increased release rate for the quaternary ammonium or other cationic biocide from the wipe is desirable so that lower actives levels may be used while providing the same efficacy for cleaning, disinfecting or sanitizing applications.

The water-resistant adhesive may be cross-linked, and/or be a co-polymer. Examples of possible cross-linking agents are described in Applicant's applications already incorporated by reference, as well as U.S. Pat. Nos. 3,855,158; 3,899,388; 4,129,528; 4,147,586; and 4,222,921, each of which is incorporated herein by reference in its entirety.

Glyoxalated polyacrylamide resins may also be used to increase wet strength. Examples of such resins are described in U.S. Pat. Nos. 3,556,932 and 3,556,933, each of which is incorporated herein by reference in its entirety.

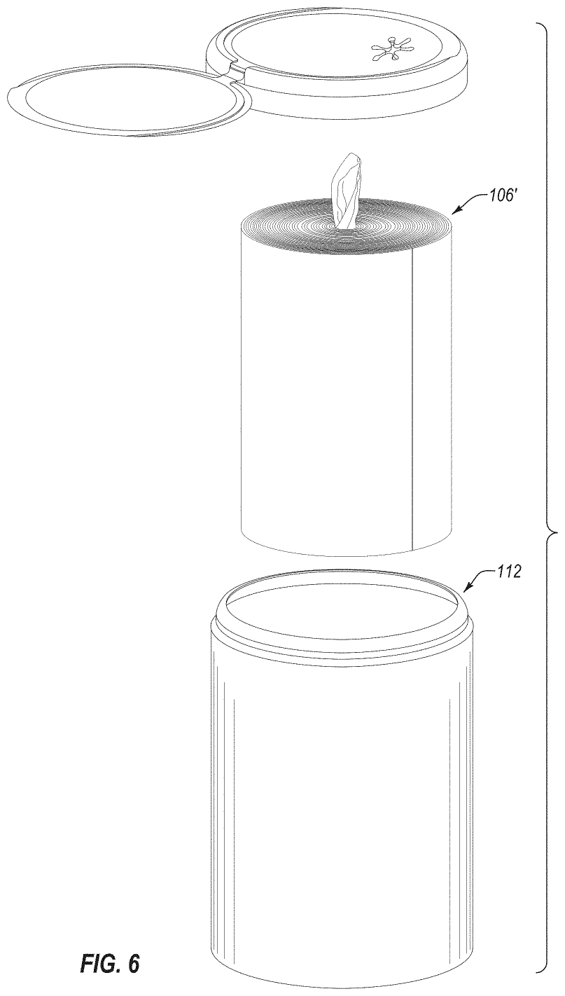

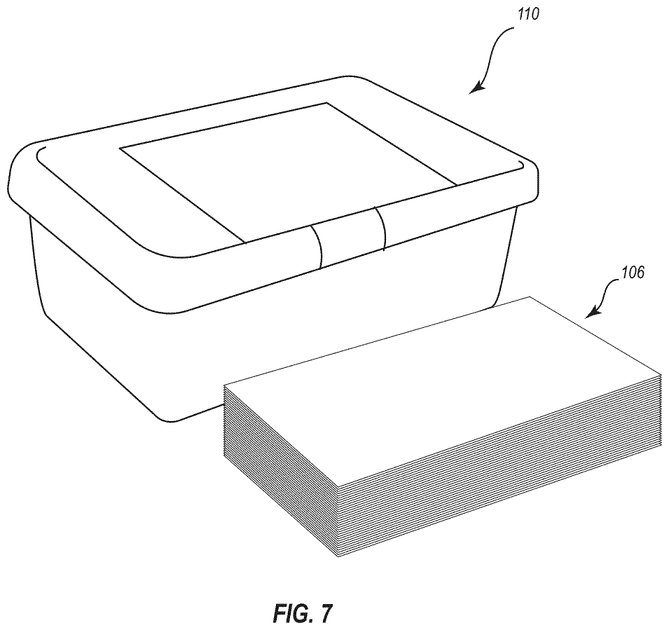

Such water-resistant adhesives can be used to adhere any two or more layers together without them falling apart or otherwise delaminating, even when pre-dosed with the cleaning composition and stored for 12 months or more in such a wetted condition. While the present wipes are principally contemplated to be provided in stacks of such wipes, it may be possible to cast or otherwise provide a film of EVA or other water-resistant adhesive having characteristics as described herein between adjacent pulp layers to create a stiffer and stronger structure that may even be sufficiently strong to accommodate conversion into a donut (e.g., the donut or roll configuration of Clorox Disinfecting Wipes in a cylindrical canister) so as to allow dispensing from a cylindrical canister, as seen in FIG. 6. Increasing the stiffness and/or tensile strength of the pulp substrate allows for dispensing container options that would not otherwise be possible. Such characteristics of increased stiffness and strength may counteract the typical increased tendency for substrates to tear when packaged in such a donut configuration. In a similar manner, such increased stiffness and/or strength may also counteract the tendency of pulp substrates to collapse once wetted, if provided in a donut configuration. In addition, in dispensing a single wipe from a donut configuration, there is relatively high friction between the wipes, thus requiring a high degree of force to pull them apart. With typical pulp substrates, such forces are sufficient to result in undesirable tears. Increased stiffness and/or strength as provided by a water-resistant adhesive as described herein may aid in overcoming such obstacles, so as to allow dispensing such pulp substrates from a donut configuration.

Table 1B shows additional details of various adhesives that were tested, and their results. The testing procedure involved 1 inch square through-air dried tissue, with application of a single drop of adhesive applied, e.g., ranging from 0.01 g to 0.5 g depending on particular sample. Large quantities of glue are from 0.2 to 0.5 g per 1 square inch. Medium quantities were 0.08 to 0.2 g, and small/low loading was less than 0.08 g per square inch. Glue was applied to one square, with the other square being laid on top, and hand pressure applied to laminate the layers. Samples were allowed to dry per adhesive instructions before exposure to lotion. Of the 20 samples tested in Table 1B, samples 11-17, 19, 22, and 25-28 and 30 were not viable. Samples 18 and 23-24 achieve bonding at low adhesive loading, but are unacceptable from a product or process standpoint. Samples 20 and 21 achieved bonding at low adhesive loading, and are acceptable from product and process standpoints.

TABLE 1B

| | | Percent | | |
|---|---|---|---|---|
| | | Solids | Viscosity | |
| Sample | Adhesive | (%) | (cps) | Results |
| 11 | Accubond TLA-EXP1 | 6.5 | 900 | 1 |
| | Fully hydrolyzed | | | |
| | PVOH | | | |
| 12 | Accubond TLA-EXP2 | 6.5 | 500 | 1 |
| | Fully hydrolyzed | | | |
| | PVOH + crosslinker | | | |
| 13 | Accubond TLA-EXP3 | 6.5 | 500 | 1 |
| | Fully hydrolyzed | | | |
| | PVOH + crosslinker | | | |
| 14 | Henkel N3040 Milky | N/A | N/A | 1 |
| | White Emulsion | | | |
| 15 | Henkel 460A Hybrid | N/A | N/A | 2 |
| | PVOH | | | |
| 16 | Accubond TLA-EXP4 | 50% | 1000 | 3 |
| | EVA | | | |
| 17 | Accubond TLA-EXP5 | 60% | 1000 | 3 |
| | EVA | | | |
| 18 | Accubond TLA-EXP6 | 70% | 1000 | 4 |
| | EVA | | | |
| 19 | Accubond CL-EXP4 | 40% | 450 | 5 |
| | EVA | | | |
| 20 | Accubond CL-EXP5 | 58% | 450 | 6 |
| | (4-0044) | | | |
| | EVA | | | |
| 21 | Accubond TLA-EXP6 | 65% | 450 | 6 |
| | EVA | | | |
| 22 | Henkel Aquence LA- | 55% | 1800 | 3 |
| | 5112 water based | | | |
| | emulsion | | | |
| 23 | Henkel BG-0271 | 55% | 2200 | 7 |
| | water based emulsion | | | |
| 24 | 3M 3762 EVA hot | 100% | N/A | 8 |
| | melt adhesive | | | |
| 25 | HB Fuller TT5000B | N/A | N/A | 1 |
| 26 | HB Fuller TT5006 | N/A | N/A | 1 |
| 27 | HB Fuller X3801XP | N/A | N/A | 1 |
| 28 | HB Fuller V386B001 | N/A | N/A | 1 |
| 29 | Solenis Polycup 9200, | N/A | ~1 | |
| | 150190-PC-NA | | | |
| | “PAE” | | | |
| 30 | Celanese 25-420 | N/A | N/A | 1 |
| | Durasoft EVA | | | |

1 = did not stay laminated when sample was exposed to cleaning lotion under all adhesive loading levels tested.
2 = somewhat successful, but only under unacceptably high adhesive loading.
3 = was able to stay laminated only under medium to high adhesive loading. Somewhat better than 2 (still unacceptable).
4 = samples remained bonded at low adhesive loading. Visosity too high.
5 = samples failed to adhere together when cleaning lotion applied. Dry solids content too low.
6 = samples stayed bonded even with low adhesive loading (successful).
7 = provides good lamination strength, but high wet tack and high viscosity.
8 = adhesive hardens to hard plastic texture, not suitable.

c. Other Characteristics

The size and shape of the wipe can vary with respect to the intended application and/or end use of the same. The cleaning substrate can have a substantially rectangular shape of a size that allows it to readily engage standard cleaning equipment or tools such as, for example, mop heads, duster heads, brush heads, mitten shaped tools for wiping or cleaning, and so forth. In another embodiment, another shape, e.g., circular, oval, or the like) may be provided.

The wipes or other cleaning substrates may be provided pre-moistened with a cleaning composition. Such composition may include an antimicrobial agent (e.g., a quaternary ammonium compound, biguanide, or other), to provide sanitization or disinfection. The wet cleaning substrates can be maintained over time in a sealable container such as, for example, within a bucket or tub with an attachable lid, sealable plastic pouches or bags, canisters, jars, and so forth. Desirably the wet, stacked cleaning substrates are maintained in a resealable container. The use of a resealable container is particularly desirable when using aqueous volatile liquid compositions since substantial amounts of liquid can evaporate while using the first sheets thereby leaving the remaining sheets with little or no liquid. Exemplary resealable containers and dispensers include, but are not limited to, those described in U.S. Pat. No. 4,171,047 to Doyle et al., U.S. Pat. No. 4,353,480 to McFadyen, U.S. Pat. No. 4,778,048 to Kaspar et al., U.S. Pat. No. 4,741,944 to Jackson et al., U.S. Pat. No. 5,595,786 to McBride et al.; the entire contents of each of the aforesaid references are incorporated herein by reference.

With regard to pre-moistened substrates, a selected amount of liquid may be added to the container or wipes during manufacture such that the cleaning substrates contain the desired amount of liquid. As described herein, preferably the substrates are not loaded to their saturation point, but are loaded with the cleaning composition to some ratio less than full saturation. For example, many substrates are capable of holding about 8 to 14 times their weight in liquid. For reasons described herein, the substrates may be loaded at a loading ratio less than saturation, e.g., less than 6:1, less than 5:1, less than 4:1, such as from 1:1 to 4:1, from 2:1 to 4:1, from 2.5:1 to 3.5:1, from 2.5:1 to 3:1 or from 2.5:1 to 3.75:1.

Typically, the cleaning substrates are stacked and placed in the container and the liquid subsequently added thereto, all during mass manufacturing. The substrate can subsequently be used to wipe a surface. The moistened cleaning substrates can be used to treat various surfaces. As used herein “treating” surfaces is used in the broad sense and includes, but is not limited to, wiping, polishing, swabbing, cleaning, washing, disinfecting, scrubbing, scouring, sanitizing, and/or applying active agents thereto.

As used herein the term “liquid” includes, but is not limited to, solutions, emulsions, suspensions and so forth. Thus, liquids may comprise and/or contain one or more of the following: disinfectants; antiseptics; diluents; surfactants, such as nonionic, anionic, cationic; waxes; antimicrobial agents; sterilants; sporicides; germicides; bactericides; fungicides; virucides; protozoacides; algicides; bacteriostats; fungistats; virustats; sanitizers; antibiotics; pesticides; and so forth. Examples of some such components are included in, but not limited to, U.S. Pat. Nos. 6,825,158; 8,648,027; 9,006,165; 9,234,165, and U.S. Publication No. 2008/003906 each of which is herein incorporated by reference in its entirety. In some embodiments, it may be possible to provide the substrates in dry form, where dosing with a selected cleaning composition may occur later (e.g., by the user).

The wipes or other cleaning substrates of the present invention can be provided in a kit form, wherein a plurality of cleaning substrates and a cleaning tool are provided in a single package.

In addition to material composition (e.g., pulp substrate, composition of the cleaning “lotion” and the like), wipe or other substrate dimensions can also be used to control dosing as well as provide ergonomic appeal. In one embodiment, substrate dimensions are from about 5½ inches to about 11 inches in length, and from about 5½ inches to about 11 inches in width to comfortably fit in a hand. The substrate can have dimensions such that the length and width differ by no more than about 2 inches. Larger substrates may be provided that can be used and then folded, either once or twice, so as to contain dirt within the inside of the fold and then the wipe can be re-used. Such larger substrates may have a length from about 5½ inches to about 13 inches and a width from about 10 inches to about 13 inches. Such substrates can be folded once or twice and still fit comfortably in the hand.

d. Cleaning Composition

Many cleaning composition components as known within the art may be suitable for use in the present pre-dosed wipes. In an embodiment, the cleaning composition is an aqueous composition, including at least 90% water by weight (e.g., 90% to 99% water). The composition may also include 0.05% to 5% by weight of a quaternary ammonium compound, and 0.1% to 5% by weight of a glycol ether solvent. For example, the quaternary ammonium compound may be included from 0.05%, from 0.1%, up to 5%, up to 4%, up to 3%, up to 2%, or up to 1% by weight of the cleaning composition. The glycol ether solvent may be included from 0.1%, from 0.25%, up to 5%, up to 4%, up to 3%, up to 2%, or up to 1% by weight of the cleaning composition. Other solvents, surfactants, and various other adjuvants often included in cleaning compositions may optionally be present. While some embodiments may include lower alcohol solvents (e.g., C₁-C₄ alcohols), the amount of such volatile solvents may be limited, e.g., to less than 10%, less than 5%, less than 3%, less than 2%, or less than 1% by weight. In some embodiments, the composition may be free of, or substantially free of, such lower alcohol or other highly volatile solvents.

Quaternary ammonium compounds have broad spectrum antimicrobial properties. A variety of different quaternary ammonium compounds can be used in the cleaning composition. Non-limiting examples of quaternary ammonium compounds are typically halides (e.g., a chloride) of alkyldimethylbenzylammonium, alkyldimethylethylbenzylammonium, alkyldimethylammonium, or the like. The alkyl groups of such quaternary ammonium compounds may typically range from C₁₂ to C₁₈. Quaternary ammonium compounds are described in more detail in U.S. Pat. No. 6,825,158, incorporated by reference herein, and will already be familiar to those of skill in the art.

The cleaning composition may include a glycol ether solvent. Exemplary glycol ether solvents include, but are not limited to, ethylene glycol monopropyl ether, ethylene glycol monobutyl ether, propylene glycol n-propyl ether, propylene glycol monobutyl ether, propylene glycol t-butyl ether, diethylene glycol monoethyl or monopropyl or monobutyl ether, di- or tri-polypropylene glycol methyl or ethyl or propyl or butyl ether, acetate and/or propionate esters of glycol ethers.

Those of skill in the art will appreciate that any among a wide variety of surfactants (e.g., anionic, cationic, non-ionic, zwitterionic, and/or amphoteric) may be included in the cleaning composition, as desired. Where included, a surfactant may be present from 0.05%, from 0.1%, up to 10%, up to 5%, up to 4%, up to 3%, up to 2%, or up to 1% by weight of the cleaning composition. Listings of exemplary surfactants are included within various of the patents and other publications already incorporated herein.

e. Stiffness and Strength Characteristics

In an embodiment, the multi-layer substrates used in the present wipes may include particular stiffness characteristics, tensile strength characteristics, and/or density of pulp fiber characteristics within the substrate. The pulp substrates may exhibit a dry stiffness value that is significantly greater than the stiffness value for the pulp substrate when wetted at a given loading ratio. By way of example, FIG. 3A illustrates stiffness values (in mg·cm) for an exemplary pulp substrate both dry and loaded at various loading ratios. FIG. 3B illustrates tensile strength (in lb_{f}), as measured in the machine direction (“MD”) for the same pulp substrate, again in a dry condition and at various loading ratios.

With synthetic substrates, tensile strength and stiffness values may not change dramatically as the substrate goes from wet to dry, but may remain substantially constant whether wetted or dry. For example, a substrate formed of 100% synthetic fibers may have a stiffness of about 63 mg·cm when dry, which decreases to about 40 mg·cm when wet. In a similar manner, the MD tensile strength of a 100% synthetic substrate is about 22 lb_{f} when dry, and 16 lb_{f} when wet. While there is a decrease in both property values, such a decrease is minor compared to what occurs upon wetting a substrate in which all or substantially all fibers therein are pulp fibers. For example, a pulp substrate may have a stiffness of about 200 mg·cm when dry, which decreases to about 48 mg·cm when wet (depending on loading ratio). In a similar manner, tensile strength is about 2.7 lb_{f} when dry, and about 0.85 lb_{f} when wet (depending on loading ratio).

By way of further explanation, stiffness may decrease by over 50%, over 60%, or over 70% upon wetting, with the present substrates. MD tensile strength may decrease by at least 40%, at least 50%, at least 60%, or at least 65% upon wetting, with the present substrates. By comparison, the decreases seen with synthetic, and even blended substrates, are not in the same category. For example, a typical synthetic substrate may show a stiffness decrease of less than 40%, and a MD tensile strength decrease of less than 30%. A blended substrate (e.g., 60% pulp fibers, 40% synthetic fibers) may show a stiffness decrease of less than 20%, and a MD tensile strength decrease of no more than 35%.

In addition, the actual values are quite different. For example, dry stiffness for the present pulp substrates may be greater than 100 mg·cm, such as from 150 mg·cm to 300 mg·cm. Such is far higher than the stiffness of dry synthetic and blended substrates (e.g., 63 mg·cm and 75 mg·cm, respectively). Wet stiffness for the present pulp substrates may be less than 70 mg·cm, or from 30 mg·cm to 60 mg·cm (e.g., at typical loading ratios described herein). The wet stiffness may actually be similar to the stiffness of wet synthetic and blended substrates (e.g., 40 mg·cm and 61 mg·cm, respectively).

Dry tensile strength for the present pulp substrates may be less than 10 lb_{f}, such as from 1 lb_{f} to 5 lb_{f}. Such is significantly lower than the tensile strength of dry synthetic and blended substrates (e.g., 22 lb_{f} and 6 lb_{f}, respectively). Wet tensile strength for the present pulp substrates may be less than 2 lb_{f}, or less than 1 lb_{f} (such as from 1 lb_{f} to 2 lb_{f}, or from 0.5 lb_{f} to 1 lb_{f}). Such is far lower than the tensile strength of wet synthetic and blended substrates (e.g., 16 lb_{f} and 3.6 lb_{f}, respectively)

The present pulp substrates may be provided with a relatively high density of pulp fibers (e.g., at least 70,000 per in²), and the substrate fibers may be made up principally, or even entirely of pulp fibers, rather than synthetic fibers. In addition to fibers present in the substrate, a small fraction of the substrate weight is made up of the water-resistant adhesive, as described herein. Even with such an adhesive or other components present, the substrate may comprise at least 70%, at least 75%, at least 80%, at least 85%, at least 90%, or at least 95% pulp fibers by weight.

Such pulp fibers derive their stiffness and tensile strength from hydrogen bonding between the fibers, such that hydrogen bonded fibers participate as strength bearing elements of the substrate. In an embodiment, the substrate may be loaded with the cleaning composition at a loading ratio such that at least 20% of the pulp fibers maintain hydrogen bonding between one another. No more than 80%, no more than 70%, no more than 60%, or no more than 50% of the pulp fibers may maintain hydrogen bonding between one another. Measurement of such hydrogen bonding characteristics may be determined by simply measuring tensile strength (e.g., MD, TD, or an average) of the substrate in a dry condition, as compared to the loaded condition.

If tensile strength or stiffness is too high, the wipe becomes difficult to bunch up, and if the tensile strength is too low, the wipe feels too flimsy in the hand. Optimal hand feel may be provided with pulp substrates as described herein, at loading ratios ranging from 1:1 to 4:1, 1:1 to 3.75:1, from 2:1 to 3.75:1, from 2:1 to 3:1, or from 2.5:1 to 3:1. At the preferred loading ratios the wipe exhibits excellent flexibility for bunching in the hand of the user, but is not so weak as to easily tear or be frustrating during use.

The substrate may have a dry stiffness of at least 100 mg·cm, at least 125 mg·cm, at least 150 mg·cm, from 150 mg·cm to 200 mg·cm, or from 175 mg·cm to 200 mg·cm. Upon wetting the stiffness may be no more than 75 mg·cm, no more than 50 mg·cm, at least 5 mg·cm, at least 10 mg·cm, or from 10 mg·cm to 30 mg·cm. Such values may be for whatever loading ratio the substrate is loaded at (e.g., at least a 1:1 loading ratio, such as 1:1, 2:1, 2.5:1, 3:1 or 4:1).

The substrate may have a dry tensile strength of at least 1.5 lb_{f}, at least 2 lb_{f}, at least 2.5 lb_{f}, e.g., from 2 lb_{f} to 3 lb_{f}. Upon wetting, the tensile strength decreases, e.g., to a value that may be no more than 1.25 lb_{f}, no more than 1 lb_{f}, at least 0.25 lb_{f}, at least 0.3 lb_{f}, at least 0.4 lb_{f} at least 0.5 lb_{f}, or from 0.5 lb_{f} to 1 lb_{f}. Such values may be for whatever loading ratio the substrate is loaded at (e.g., at least a 1:1 loading ratio, such as 1:1, 2:1, 2.5:1, 3:1, or the like).

The basis weight of the multi-layer substrate, including the adhesive may be no more than 100 g/cm², no more than 75 g/cm², at least 35 g/cm², from 40 g/cm² to 65 g/cm², from 45 g/cm² to 60 g/cm², or from 50 g/cm² to 55 g/cm². Units of g/cm² are of course also routinely expressed as gsm. The adhesive portion of the substrate may account for less than 10 g/cm², at least 1 g/cm², at least 2 g/cm², from 2 g/cm² to 8 g/cm², or from 3 g/cm² to 5 g/cm² of the basis weight.

Table 2A below shows numbers of pulp fibers within exemplary pulp substrates as compared to synthetic substrates and blended substrates that include both pulp fibers and synthetic fibers. Numbers of pulp fibers within a substrate may be determined by various methods. For example, one may count the fibers within a given area or volume of a SEM image, and then extrapolate such number to the wipe as a whole (or per in²). Another method (which was used by Applicant to determine the values reported herein) may include making a calculation as described below.

The following formula was used to estimate the number of fibers in the substrates described herein. Number of fibers=(Mass of substrate in grams)/(Mass of fiber in grams). For blended substrates the mass was determined as a percentage of the blend contribution to the final mass.

Because the wood pulp fibers are ribbon shaped, fiber length (1), breadth (b) and width (w) were measured using an SEM microscope. The volume of the wood pulp fiber was calculated using the formula Volume=l·b·w (cm³). The density was obtained from the literature, in g/cm³. Such density values for various varietals typically range from 20 lb/ft³ (0.32 g/cm³) to 30 lb/ft³ (0.49 g/cm³). The mass in grams was calculated using the formula mass (g)=Density (g/cm³)×volume (cm³).

Because synthetic fibers of interest in this application are generally cylindrical, the diameter of the cylinder was measured using an SEM microscope. The volume of the synthetic fiber was calculated using the formula Volume=π·R²·L (where L=length of the fiber, and R=fiber radius). The density was obtained from the literature, in g/cm³. The mass in grams was calculated using the formula mass (g)=Density (g/cm³)×volume (cm³).

TABLE 2A

| | Basis | | No. of | No of |
|---|---|---|---|---|
| Sample | Weight | No. of | Synthetic | Pulp Fibers |
| (7 in × 8 in) | (gsm) | Pulp Fibers | Fibers | per in² |
| High Texture | 41 | 4,135,065 | 0 | 73,840 |
| 100% Pulp | | | | |
| Low Texture | 48 | 5,168,831 | 0 | 92,300 |
| 100% Pulp | | | | |
| Blend of 60% | 52 | 3,116,883 | 38,647 | 55,659 |
| Pulp/40% | | | | |
| Synthetic - | | | | |
| No Texture | | | | |
| 100% | 52 | 0 | 248,447 | 0 |
| Synthetic - | | | | |
| No Texture | | | | |

Table 2B shows percentage and number of pulp fibers that are participating as strength bearing elements for the two 100% pulp samples of Table 2A, at various loading ratios, as well as the number in each substrate (High texture versus Low texture) on a per square inch basis.

TABLE 2B

| | % Pulp Fibers | No. of Pulp Fibers | | | |
|---|---|---|---|---|---|
| | Participating | Participating (High | No. of Pulp Fibers | No of Pulp Fibers | |
| Loading | Based on | Localized | Participating (Low | Participating per in² | |
| Ratio | Tensile Strength | Texture Substrate) | Texture Substrate) | High T | Low T |
| 0 (Dry) | 100 | 4,135,065 | 5,168,831 | 73,840 | 92,300 |
| 1:1 | 36 | 1,488,623 | 1,860,779 | 26,582 | 33,228 |
| 2:1 | 30 | 1,240,519 | 1,550,649 | 22,152 | 27,690 |
| 2.5:1 | 26 | 1,075,117 | 1,343,896 | 19,200 | 24,000 |
| 3:1 | 21 | 868,364 | 1,085,455 | 16,042 | 19,383 |
| Saturation | 18 | 744,312 | 930,390 | 13,291 | 16,614 |

It will be apparent that the substrates may thus rely on hydrogen bonding for strength, rather than stronger forces that may be present in synthetic fiber based substrates (e.g., covalent bonds present in cross-linked molecules or materials). Such hydrogen bonds significantly decrease in strength (or the number of such hydrogen bonds decreases) when water is added, such as would be present in the cleaning compositions contemplated herein.

The percentage of pulp fibers that maintain hydrogen bonding with one another may be at least 20%, e.g., from 20% to 30% of the pulp fibers, or 25% to 30%, such as 20%, 21%, 22%, 23%, 24%, 25%, 26%, 27%, 28%, 29%, or 30%. Similarly, the density of pulp fibers participating in hydrogen bonding may be at least 15,000 per in², such as 15,000 per in² to 35,000 per in², from 15,000 per in² to 30,000 per in², or from 15,000 per in² to 25,000 per in², such as 15,000 per in², 16,000 per in², 17,000 per in², 18,000 per in², 19,000 per in², 20,000 per in², 21,000 per in², 22,000 per in², 23,000 per in², 24,000 per in², 25,000 per in², 26,000 per in², 27,000 per in², 28,000 per in², 29,000 per in², or 30,000 perm².

f. Wet Bulk Factor

Wet bulk factor is defined as the ratio of the profile height of the dry substrate relative to the profile height of the substrate following wetting and redrying. In other words, the wet bulk factor is a measure of the degree of compression (or expansion) exhibited by the particular substrate following wetting, and subsequent redrying. Applicant has observed that synthetic substrates, and even substrates that include a blend of synthetic fibers and pulp fibers with a large fraction of synthetic fibers in the blend, tend to exhibit relatively low wet bulk factor values. Substrates according to the present invention may include relatively high wet bulk factor values, e.g., such as at least 1.5, at least 1.55, at least 1.6, from 1.5 to 2, or from 1.6 to 2. Examples of such may include 1.5, 1.55, 1.6, 1.65, 1.7, 1.75, 1.8 1.85, 1.9, 1.95, or 2.0.

As explained above, the substrate has both a dry profile height (after wetting and redrying) and a wet profile height. Furthermore, as described herein, the substrate preferably has highly localized texture, so that the bulk thickness of the substrate is far less than the profile heights (i.e., because of the textured characteristics). For example, when measured with calipers, the substrate may have a thickness of only about 0.2 mm (200 μm), although when measured not on a bulk scale, but using a profile-o-meter, e.g., which can be used to chart profile height for any given distance across the substrate, the dry profile height (before wetting) may be from 1000 μm to 1400 μm, or 1000 μm to 1200 μm. The profile height after wetting and redrying (i.e., wet profile height) may be 400 μm to 800 μm, or 500 μm to 700 μm. In other words, after wetting and redrying, the profile is compressed compared to what it was prior to wetting in the first place. Any profile-o-meter (e.g., such as those commercially available) may be used for such measurements.

The “rough” characteristics of the profile are apparent from FIGS. 1A and 1B, where the localized regions of higher pulp fiber density are apparent, resulting in not only regions of higher fiber density, but in a configuration where these same regions are also raised so as to protrude relative to the surrounding portions of the substrate. The reverse of the substrate (see FIG. 1B) may exhibit an inverse pattern, so that on the opposite face, those areas that are “raised” (in FIG. 1A) are “recessed” on the opposite face (in FIG. 1B). Similarly, those regions that on the first face surround the raised region (and are thus the lowest points of the substrate) are raised on the opposite face, where the surrounding raised regions surround the recessed region, on the opposite face. While FIGS. 1A-1B show textured substrates, it will be apparent that other embodiments may not necessarily include such texturing (e.g., FIG. 2C).

Table 3 shows exemplary wet bulk factor characteristics for various tested substrates.

TABLE 3

| | Wet Bulk Factor (Dry/Wet |
|---|---|
| Substrate | Profile Height Ratio) |
| 100% Synthetic | 1.19 |
| Substrate - 1 | |
| 100% Synthetic | 1.14 |
| Substrate - 2 | |
| 100% Synthetic | 1.00 |
| Substrate - 3 | |
| 60/40 Blend - 1 | 0.84 |
| 60/40 Blend - 2 | 0.91 |
| 60/40 Blend - 3 | 0.93 |
| 60/40 Blend - 4 | 1.00 |
| 60/40 Blend - 5 | 1.08 |
| 60/40 Blend - 6 | 1.26 |
| 100% Pulp substrate | 1.30 |
| with light overall | |
| texture | |
| 100% Pulp substrate | 1.45 |
| with no texture | |
| 100% Pulp substrate | 1.71 |
| with high localized | |
| texture & low LR | |
| 100% Pulp substrate | 1.84 |
| with high localized | |
| texture | |

Both synthetic substrate—1 and synthetic substrate—2 were different wipe products including scrubbing zones. Synthetic substrate—3 was a synthetic wipe product without any texture. Each of the blended wipes include a 60/40 pulp/synthetic fiber blend. Blend—1 included a high localized texture, Blend—2 included the same texture, loaded at a low LR (LR=2.5:1). Blend—3 was another wipe with high localized texture, Blend—4 had no texture, Blend—5 had light texture, and Blend—6 also had no texture. The results show that even with different substrate textures and other characteristics, the synthetic and blended substrates consistently provide significantly lower wet bulk factor values than the pulp substrates.

g. Substrate Pore Size Distribution

The substrate may exhibit particular pore size distribution characteristics. For example, the pulp substrates may be such that most pores have a size greater than 200 μm, such as 300 μm to 400 μm, rather than smaller (e.g., less than 200 μm) pores. Such larger pore sizes may account for a majority of the pores, or at least more of the pores than any smaller pore size range. In a preferred embodiment, the selected multi-layer substrate may have less than 60%, more preferred less than 50% or less than 40% of total percentage of pores for the substrate within the pore size range of 0-200 μm. In an embodiment, the selected multi-layer substrate is such that more than 30%, more than 40%, more than 50%, or more than 60% of total percentage of pores for the substrate are within the pore size range of 300-400 μm. Such determination may be made on a numerical, rather than a volumetric basis. Synthetic substrates used in the field typically include far more smaller sized pores, e.g., where most pores have a size of less than 200 μm.

Table 4A below provides pore size distribution data for various substrates that were tested to determine their pore size distribution characteristics. Table 4B provides data relative to the number of pores for the same substrates as in Table 4A. Table 4C provides data on number of pores per square inch, for the various pore size ranges, for the same substrates.

TABLE 4A

| | Pore Size (μm) | | | Density |
|---|---|---|---|---|
| | 0-200 μm | 200-300 μm | 300-400 μm | (g/cm³) |
| 100% Synthetic | 87% | 8% | 4% | 0.12 |
| Substrate | | | | |
| 60/40 Blend (w/o | 87% | 13% | 0% | 0.13 |
| texture) | | | | |
| 60/40 Blend (w/high | 64% | 7% | 30% | 0.1 |
| localized texture) | | | | |
| 100% Pulp substrate | 64% | 21% | 15% | 0.05 |
| with light overall | | | | |
| texture | | | | |
| 100% Pulp substrate | 32% | 7% | 61% | 0.06 |
| with high localized | | | | |
| texture | | | | |

TABLE 4B

| | Pore Size (μm) | | | |
|---|---|---|---|---|
| | 0-200 μm | 200-300 μm | 300-400 μm | Total Pores |
| 100% Synthetic | 20,010,000 | 1,840,000 | 920,000 | 23,000,000 |
| Substrate | | | | |
| 60/40 Blend | 15,660,000 | 2,340,000 | 0 | 18,000,000 |
| (w/o texture) | | | | |
| 60/40 Blend | 12,160,000 | 1,330,000 | 5,700,000 | 19,000,000 |
| (w/high | | | | |
| localized | | | | |
| texture) | | | | |
| 100% Pulp | 10,240,000 | 3,360,000 | 2,400,000 | 16,000,000 |
| substrate with | | | | |
| light overall | | | | |
| texture | | | | |
| 100% Pulp | 4,480,000 | 980,000 | 8,540,000 | 14,000,000 |
| substrate with | | | | |
| high localized | | | | |
| texture | | | | |

TABLE 4C

| | Pore Size (μm) | | | |
|---|---|---|---|---|
| | 0-200 μm | 200-300 μm | 300-400 μm | Total Pores |
| | (per in²) | (per in²) | (per in²) | (per in²) |
| 100% Synthetic | 357,000 | 32,900 | 16,400 | 411,000 |
| Substrate | | | | |
| 60/40 Blend | 280,000 | 41,800 | 0 | 321,000 |
| (w/o texture) | | | | |
| 60/40 Blend | 217,000 | 23,800 | 101,800 | 339,000 |
| (w/high | | | | |
| localized | | | | |
| texture) | | | | |
| 100% Pulp | 183,000 | 60,000 | 42,900 | 286,000 |
| substrate with | | | | |
| light overall | | | | |
| texture | | | | |
| 100% Pulp | 80,000 | 17,500 | 153,000 | 250,000 |
| substrate with | | | | |
| high localized | | | | |
| texture | | | | |

As shown, both synthetic, and even blended substrates (e.g., 40% synthetic, 60% pulp) are similar to one another in their pore distribution characteristics, where all such tested substrates are characterized by small pores, sized 200 μm or less. A substrate with a high localized texture will have more variation in the z-direction fibers so that the thickness of the substrate will vary along the surface that has a high localized texture. The texture may take on a variety of different shapes, by way of example and not limitation, the texture of may be quilted, bumpy, rough, tufted, etc. High localized texture is the opposite of a flat substrate where there is little or no perceived texture, or such z-dimension variation. Light overall texture falls between the high localized texture and the substrates without any texture. Textures can be quantified using imaging techniques, caliper measurements, and/or profile-o-meter measurements, as described herein.

Addition of texturing to the blended substrate shows an increase in the fraction of larger pore sizes, but the blended substrate with high localized texture may also include a significant fraction of small pores sized 200 μm or less. The 100% pulp substrate with high localized texture includes significantly different pore distribution characteristics, where most pores are larger, in the size range of 300-400 μm. There are still a significant number of smaller pores, sized 200 μm or less, but this is no longer the predominant size.

This present multi-layer pulp substrates will preferably exhibit advantageous characteristics relative to hand feel, retention of cleaning composition, and release profile characteristics, as well as desirable microefficacy characteristics. The larger pore size may play a role in at least some of these desirable characteristics.

Table 4A further provides density data for the tested substrates. The pulp substrates may also exhibit lower density as compared to existing substrates used in existing wipes. For example, density (e.g., dry density) of the pulp substrate may be less than 0.1 g/cm³ (e.g., from 0.03 g/cm³ to 0.08 g/cm³, or from 0.04 g/cm³ to 0.07 g/cm³). The measured decreased density may also correspond to the presence of larger pore sizes, as also shown in Tables 4A-4B.

Table 4B further shows how the pulp substrate with high localized texture includes less overall pores, with larger pore sizes (as shown in Table 4A), as compared to the other tested substrates. The number of pores may be estimated by generating pore volume distribution data using a PMI Liquid Extrusion Porosimeter, or the like. Such porosimeters may calculate the number of pores based on an assumption that all pores are cylindrical, and by using the Young-LaPlace equation. It will be appreciated that other tools or calculations may also be suitable for estimating or calculating the number of pores.

h. Other Lotion Retention Characteristics

Applicant has observed other unique and advantageous characteristics with the particular substrate selection, in terms of how a cleaning composition loaded into the substrates is released during use. As noted above, many existing wipes have a tendency to “dump” their cleaning composition quickly, rather providing a relatively uniform dosing of the cleaning composition during wiping, which would increase mileage of the wipe. For example, when squeezing or centrifuging a typical synthetic or blended wipe under controlled conditions, more than 50% of the cleaning composition is released, leaving only a small fraction retained within the wipe. Such compression (e.g., using a conventional lemon press, or a centrifuge) is indicative of the tendency of conventional wipes to “dump” their composition quickly during wiping or other normal use. The present wipes include a far higher fraction of pulp, and preferably a localized, high degree of texture. Significantly more of the cleaning composition is retained under compression test conditions. For example, when tested in the same way (e.g., compressed in a lemon press or centrifuged) the wipe may exhibit retention of at least 50% of the cleaning composition. This ability to better retain the composition when the wipe is compressed advantageously increases the mileage of the wipe, allowing greater cleaning, disinfection, or sanitization of a given surface area with a given wipe.

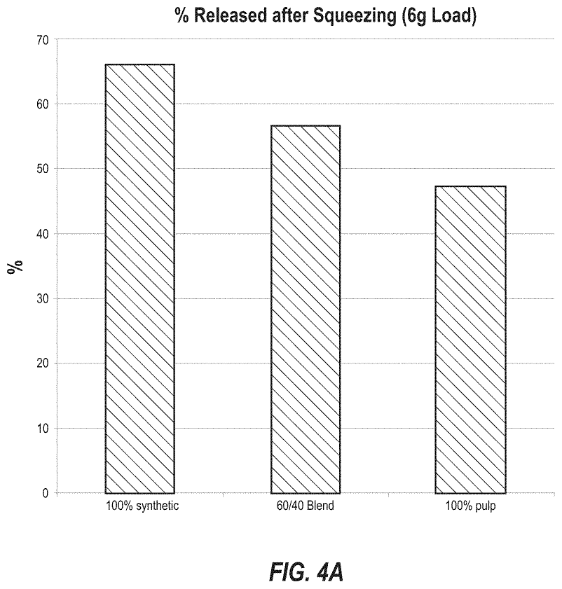

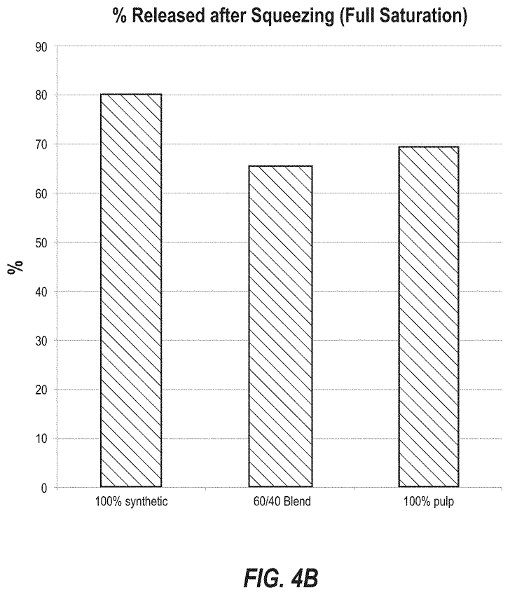

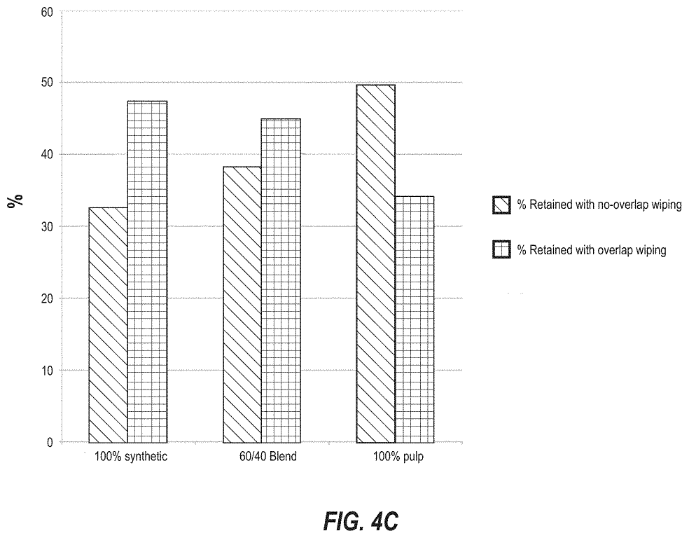

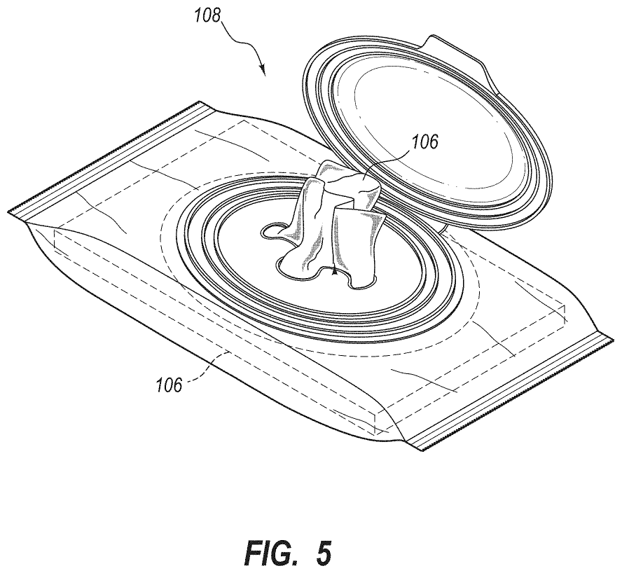

FIG. 4A shows test results for such retention versus release for synthetic, blended, and 100% pulp substrates, where the substrates are loaded with 6 grams of cleaning composition. When loaded with 6 g of cleaning composition, each of the tested substrates had a loading ratio of 5:1. Each tested substrate measured 7 inches×7 inches.

FIG. 4B shows results for the same substrates loaded to full saturation. As noted herein, loading to full saturation is not preferred for various reasons. Full saturation for the synthetic substrate was at loading ratio of 7:1, full saturation for the pulp substrate was at a loading ratio of 7:1, and full saturation for the 60/40 blended substrate was at a loading ratio of 6:1. For FIGS. 4A and 4B, the wipes were simply compressed using a lemon press. Other methods of simply squeezing (or centrifuging) the composition from the wipe could similarly be used, and would provide similar results.

FIG. 4C shows retention of cleaning composition in the wipe for the same substrates, but tested by a different methodology, intended to simulate retention and release characteristics during wiping. Two different wiping regimes (with and without overlap) were tested. Specifically, according to one regime, the wipe was wiped across a target surface being treated, with no overlap in wiping. According to the other regime, the wipe was wiped across the target surface, and there was overlap (e.g., a back and forth wiping regime). The wiping regime including overlap may closely approximate actual usage conditions of many consumers, as many consumers will often wipe a surface in a manner that they wipe again over the same portion of the surface that has already been wiped by the cleaning wipe.

The results shown in FIG. 4C show that the 100% pulp substrate retains the most cleaning composition under the no overlap wiping regime. Specifically, the pulp substrate retains approximately 50% of the cleaning composition, as compared to retention of less than 40%, and less than 35% for the blended, and synthetic substrates, respectively. Such increased retention of the cleaning composition results in increased useable life (i.e., increased mileage) for the 100% pulp wipe, as compared to the others.

The results shown in FIG. 4C also show that under the wiping regime with overlap, the 100% pulp substrate actually retains the least amount of cleaning composition. Specifically the pulp substrate retains about 35%, while the blended and synthetic wipes retain about 45% and about 48%, respectively. The results under such a wiping regime show that the pulp substrates have the greatest usefulness of the 3 tested substrates, in that more of the cleaning composition is actually being delivered, where it is needed for sanitization or disinfection. A possible explanation of the observed phenomenon is that the synthetic and blended substrates tend to quickly “dump” their composition from the wipe onto the surface being treated. As the wipe is wiped over this soaked area again (during the overlap portion of the wiping regime), the wipe actually reabsorbs a portion of the cleaning composition, increasing the percentage it then retains. Such results are further evidence of the lack of controlled release and delivery of cleaning compositions from existing synthetic and blended substrates, which tend to “dump”, and then to reabsorb, if overlap wiped.

The 100% pulp substrates on the other hand tend to deliver a more uniform dosage of the cleaning composition across all portions of the surface area being treated, no matter the wiping regime. Such uniformity of dosage increases the reliability and effectiveness of sanitization and/or disinfection over the entire treated surface. For example, while areas in which the composition is “dumped” by a synthetic or blended wipe may exhibit good sanitization and/or disinfection (if not overlap wiped) because of the excess delivery of cleaning composition to those areas, other regions of the treated surface area may not receive sufficient cleaning composition for desired efficacy. The cleaning results may thus be “spotty” as some areas will not be uniformly dosed with the cleaning composition. The pulp substrates as described herein will exhibit more uniform dosing of the cleaning composition over the surface area being treated, so as to provide sufficient cleaning composition over all regions of the surface area, providing more effective sanitization or disinfection over the entire treated surface.

Another characteristic apparent from an analysis of FIG. 4C is that the pulp substrate exhibits lower retention for an overlap application method as compared to the retention when applied with an overlap wiping method, which is exactly opposite that seen with synthetic and blended substrates (which exhibit higher retention with overlap, as compared to without). This unique characteristic of the pulp substrates as compared to the blended and synthetic substrates is believed to be indicative of the blended and synthetic wipe's tendency to “dump”, whereas the pulp substrate does not exhibit this characteristic, but delivers a more uniform, dosed quantity of the lotion throughout the wiping motion, no matter if the wiping is in an overlap or no overlap regime.

Another characteristic related to absorbency that has been observed by Applicant is that existing pre-loaded wipe products are not particularly good at absorbing light spills. For example, the synthetic or blended substrates are typically loaded at relatively high loading ratios in order to ensure sufficient antimicrobial agent is delivered to the surface being treated, and also in an attempt to partially compensate for the tendency of the composition to be “dumped” when the user first compresses the wipe, either by squeezing or wiping a surface. The present wipes including a pulp substrate, on the other hand exhibit far greater absorbency, which allows such wipes to be used to clean up (i.e., absorb) light spills from the target surface, while at the same time delivering an antimicrobial agent to the target surface. Stated another way, because the present wipes are not loaded to saturation, they have the ability to better absorb light spills during use. Blended or synthetic wipes are loaded much closer to saturation in order to provide desired microefficacy, so that they do not exhibit this advantage. Such a combination of features is simply not possible with current wipes based on synthetic and blended substrates. The present wipes are able to achieve desired microefficacy results at relatively low loading ratios, while at the same time providing significant absorptive capacity for absorbing liquid spills from the same target surface to which the cleaning composition is being delivered.

i. MABDF

Many of the characteristics described herein relative to the pulp substrates may be represented in an empirical measurement, defined as mileage absorbency/desorbency factor (MABDF), where MABDF is defined as:

$$\frac{( R + P + S )}{( ρ + TS )}$$

where R is the percentage of composition retained upon squeezing, P is the percentage of pulp in the substrate, S is the stiffness of the wipe (in mg·cm), p is the density of the wipe (in gm/cm³), and TS is the tensile strength of the substrate (in lb_{f}). MABDF empirical values may be determined for both wet and dry conditions, as values such as stiffness and tensile strength may change significantly depending on whether the wipe is wet or dry. An average MABDF may also be determined, as an average of the wet and dry values.

The MABDF empirical value is indicative of how well the substrate retains the cleaning composition so as to deliver it in a relatively uniformly dosed way, over the useful life of the wipe, as opposed to “dumping” the composition very quickly, well before the durability characteristics of the substrate have been expended. MABDF may also be indicative of other advantageous characteristics as described herein, e.g., such as microefficacy, desirable hand feel characteristics, and the like. MABDF thus serves as a quick indicator as to the suitability of a given substrate for use as a pre-dosed wipe according to the present invention.

Such MABDF values for the present wipes may be significantly higher than for existing commercially available wipes, which are based on synthetic or blended substrates. Tables 5A-5B below show various values that go into the MABDF determination, as well as MABDF values for various tested wipes. Table 5C shows average MABDF values.

TABLE 5A
Dry MABDF

| | 100% Pulp | 100% Pulp | 60/40 | 100% Synthetic |
|---|---|---|---|---|
| | substrate - 1 | substrate - 2 | Blend | Substrate |
| Wet Density | 0.05 | 0.07 | 0.13 | 0.12 |
| (g/cm³) | | | | |
| Saturation | 14 | 8 | 8 | 11 |
| Capacity (g) | | | | |
| Percent Retained | 31 | 41 | 35 | 20 |
| Percent Released | 69 | 59 | 65 | 80 |
| MD Dry Tensile | 2.68 | 2.68 | 5.58 | 21.93 |
| Strength (lb_{f}) | | | | |
| Percentage Pulp | 99.5 | 99.5 | 60 | 0 |
| Dry Stiffness | 200 | 200 | 75 | 63 |
| (mg · cm) | | | | |
| MABDF - Dry | 126 | 127 | 31 | 4 |

TABLE 5B
Wet MABDF

| | 100% Pulp | 100% Pulp | 60/40 | 100% Synthetic |
|---|---|---|---|---|
| | substrate - 2 | substrate - 1 | Blend | Substrate |
| Wet Density | 0.05 | 0.07 | 0.13 | 0.12 |
| (g/cm³) | | | | |
| Saturation | 14 | 8 | 8 | 11 |
| Capacity (g) | | | | |
| Percent Retained | 31 | 41 | 35 | 20 |
| Percent Released | 69 | 59 | 65 | 80 |
| MD Wet Tensile | 0.84 | 0.84 | 3.62 | 15.61 |
| Strength (lb_{f}) | | | | |
| Percentage Pulp | 99.5 | 99.5 | 60 | 0 |
| Wet Stiffness | 48 | 48 | 61 | 40 |
| (mg · cm) | | | | |
| MABDF - Wet | 217 | 216 | 44 | 5 |

TABLE 5C
Average MABDF

| | 100% Pulp | 100% Pulp | 60/40 | 100% Synthetic |
|---|---|---|---|---|
| | substrate - 2 | substrate - 1 | Blend | Substrate |
| MABDF - Avg | 172 | 172 | 37 | 4 |

As seen, wet, dry, and average MABDF values for wipes according to the present invention may be greater than 50, at least 60, at least 70, at least 80, at least 90, or at least 100, from 80 to 400, from 80 to 300, from 100 to 300, or from 100 to 250. Such values are far higher than for synthetic wipes (e.g., which are less than 10), or blended substrate wipes (which are less than 50, or less than 45 or less than 40). In addition, the differences between MABDF dry and wet values are of interest. For example, MABDF values for the exemplary inventive wipe substrates increase dramatically from dry to wet (e.g., increases of 50% or more, 60% or more, or 70% or more), while MABDF values for synthetic substrates are practically unchanged (and very low) for both wet and dry conditions or calculations. While the blended substrate exhibits some increase in going from dry to wet, the increase is less dramatic than observed for the desired pulp substrates having high MABDF values.

j. Antimicrobial Efficacy

Various types of pulp substrates and other substrates were tested for their ability to effectively deliver an antimicrobial quaternary ammonium compound to a surface during simulated cleaning. Applicant noted that the generally anionic characteristics of typical pulp substrates leads to a tendency of the substrate to bind or otherwise retain the cationic quaternary ammonium compound, even when squeezing an aqueous cleaning composition from the pulp substrate. In other words, typically, the concentration of quaternary ammonium compound in the “squeezate” (the cleaning composition as squeezed from the pre-loaded wipe) is less than the concentration of quaternary ammonium compound in the cleaning composition before it was loaded into the wipe. Since quaternary ammonium compounds are known to bind to pulp substrates, it was unexpected that the present wipes were able to release a significant enough portion of the quaternary ammonium compound to achieve disinfectancy and/or sanitization on a treated surface without the inclusion of a biocide release agent or latex binder in the substrate.

Because of this characteristic, it can be important to ensure that sufficient quaternary ammonium compound is included in the composition as loaded to ensure there is sufficient in the squeezate to provide a desired degree of antimicrobial efficacy. Of course, as described herein, particular selections can be made relative to physical characteristics of the substrate to also increase release of the quat. For example, in an embodiment, the wipes release at least 20% of the quaternary ammonium compound (i.e., quaternary ammonium compound in the squeezate as compared to the cleaning composition before loading). By way of further example, the wipes may exhibit at least a 3-log reduction in a target microbe, such as Staphylococcus aureus, within a given time frame (e.g., such as 5 minutes, 1 minute, 30 seconds, 10 seconds, etc.).

Table 6 shows the results of testing in which a cleaning composition including 0.363% of a quaternary ammonium compound was loaded into several different types of substrates. The cleaning composition was squeezed therefrom, and the squeezate was analyzed to determine the concentration of the quaternary ammonium compound therein.

TABLE 6

| | % Quat in Cleaning | % Quat in | % Quat |
|---|---|---|---|
| Substrate | Composition | Squeezate | Released |
| 60/40 synthetic | 0.363 | 0.160 | 44.11% |
| blend with high | | | |
| localized texture | | | |
| 100% pulp with | 0.363 | 0.235 | 64.90% |
| latex binder | | | |
| 100% pulp with | 0.363 | 0.085 | 23.39% |
| light texture | | | |
| 100% pulp with | 0.363 | 0.161 | 44.27% |
| high localized | | | |
| texture | | | |

While inclusion of a latex binder in the substrate increases the percentage of the quaternary ammonium compound (quat) being released, in an embodiment, no latex binders are added to the substrate, as such inclusion increases complexity of manufacture (and costs), and reduces the strength of the substrate when wet, which is particularly problematic. Such latex binders may be characterized as cationic biocide release agents, for purposes of the present application. In an embodiment, the present wipes are preferably free of such cationic biocide release agents, as while they may increase release of the cationic biocide, such cationic agents introduce other problems.

For example, while cationic latex may block some of the anionic binding sites of the pulp substrate so as to increase quat release, the latex decreases strength and otherwise negatively affects the hand feel characteristics of the wipe, particularly when wet. Similarly, cationic salts might be added to the composition or otherwise provided within the wipe for a similar purpose, but such salts lead to undesirable streaking and film formation characteristics associated with the wipe. Thus, in an embodiment, the wipe is free of or at least substantially free of such cationic biocide release agents. Materials that have applicability both as binders and processing aids may be used in small amounts as a processing aid for wet strength in pulp substrate processing. Examples of such materials include KYMENE, cellulose gum, sodium carboxymethylcellulose (CMC) or the like. Such materials may be present at low levels (e.g. less than 1% by weight, less than 0.5% by weight, less than 0.2% by weight, less than 0.1% by weight, less than 0.05%, or the like) in the inventive wipes, not as binders, but simply because they are commonly used in the manufacture of pulp substrate materials (e.g., as a processing aid).

Without the aid of such release agents, the wipe may release at least 20%, at least 25%, at least 30%, at least 35%, at least 40%, up to 100%, up to 90%, up to 80%, up to 70%, up to 60%, up to 50%, from 20% to 60%, or from 30% to 50% of the quaternary ammonium compound upon squeezing (e.g., use or simulated use).

Further testing was conducted to analyze microefficacy of the present wipes against Staphylococcus aureus. Two cleaning compositions were tested, as shown in Table 7 below. The percentages are for the cleaning composition prior to loading (i.e., the squeezate will have less quat).

TABLE 7

| | Formula 1 | Formula 2 | Formula 3 |
|---|---|---|---|
| Quat % | 0.367 | 0.27 | 0.367 |
| Lower Control Limit (LCL) | 0.33 | 0.22 | 0.33 |
| Target Quat Level | 0.367 | 0.27 | 0.367 |
| Upper Control Limit (UCL) | 0.42 | 0.32 | 0.42 |
| Nonionic Surfactant % | 0.44 | 0.3 | 0.11 |
| Na-bicarbonate % | 0.006 | 0.006 | 0 |
| Citric Acid % | 0.005 | 0.005 | 0 |
| Glycol Ether solvent % | 1.83 | 1 | 1.00 |
| IPA % | 0.45 | 0.39 | 0.45 |
| Fragrance % | 0.1 | 0.1 | 0.12 |
| Water | Balance | Balance | Balance |

Both formulas were tested using 100% pulp substrates, having a high localized texture, such as seen in FIGS. 1A-1C. Various different loading ratios and contact times were tested for disinfection and/or sanitization ability. Table 8 shows the results of such testing.

TABLE 8

| | Loading | Contact Time | |
|---|---|---|---|
| Sample | Ratio | (min) | Result |
| Formula 1 with | 3.75:1 | 4:45 | Pass |
| 100% pulp with high | | | |
| localized texture | | | |
| Formula 1 with | 3.75:1 | 9:45 | Pass |
| 100% pulp with high | | | |
| localized texture | | | |
| Formula 2 with | 3.75:1 | 4:45 | Potential to |
| 100% pulp with high | | | Pass |
| localized texture | | | |
| Formula 2 with | 3.75:1 | 9:45 | Pass |
| 100% pulp with high | | | |
| localized texture | | | |

Testing was conducted against Staphylococcus aureus according to ATCC [6538], using 10 carrier wipes for each test. In each “Pass” result, no growth of the Staphylococcus aureus target organism was detected (0/10 plates). Growth was detected in 2 out of 10 plates at the 4:45 min contact time for Formula 2, indicating that upon retesting, there is the potential for a passing result. A “Pass” is achieved so long as there is no more than 1 failure (growth) out of 10 assays. The results are sufficient to support a disinfection claim (e.g., a log 6 reduction) against Staphylococcus aureus for about 5 and about 10 minute contact times.

In addition to testing a loading ratio of 3.75:1 at 5 and 10 minute contact times, loading ratios of 2, 2.5 and 3 were also tested, using the same 100% pulp high texture substrates as described above in conjunction with Table 8. In a similar manner as described above, 10 carrier wipes were each tested against Staphylococcus aureus under ATCC [6538]. All examples passed, supporting a sanitization claim against Staphylococcus aureus at a 5 minute contact time. In all such microefficacy testing procedures, the tested 100% pulp substrates were each 11 inches by 10.25 inches. The substrates were each individually folded in half along the 11 inch side, and stacked on each other (alternate the folded edge), and then loaded with the cleaning composition. The resulting stacks of 10 folded substrates were folded in half again to result in a substantially square geometry (5.5×5.125 inches). The neutralizer employed in such testing was Letheen broth, with 0.28% lecithin and 2% tween 80. Exposure temperature was 21° C. Soil load was 5% fetal bovine serum. The wiping procedure for each wipe was over and back two times (4 single passes total). Unmatted petri dishes were used in testing.

At a loading ratio of 2:1, all 10 wipes were dry at the end of the 4:45 exposure period. At a loading ratio of 2.5:1, four of the 10 wipes were dry at the end of the 4:45 exposure period. At a loading ratio of 3:1, one wipe was dry, and another wipe was only partially wet after the exposure period. All samples, at loading ratios of 2:1, 2:5:1, and 3:1 passed the 4:45 sanitization test (i.e., at least a 3-log reduction in Staphylococcus aureus). The controls for each test had Staphylococcus aureus populations of 6.06 average Log₁₀, 6.03 average Log₁₀, and 6.04 average Log₁₀ for LRs of 2:1, 2.5:1, and 3:1, respectively.

TABLE 9

| | Load- | Contact | Staphylococcus | Klebsiella |
|---|---|---|---|---|
| | ing | Time | aureus | pneumoniae |
| Sample | Ratio | (seconds) | [ATCC 6538] | [ATCC 4352] |
| Formula 3 with | 3:1 | 10 seconds | Fail | Pass |
| 1 Ply low | | | | |
| texture substrate | | | | |
| Formula 3 with | 3:1 | 10 seconds | Pass | Pass |
| 2 Ply low | | | | |
| texture substrate | | | | |
| Formula 3 with | 3:1 | 30 seconds | Pass | Pass |
| 1 Ply low | | | | |
| texture substrate | | | | |

Testing was conducted against Staphylococcus aureus according to ATCC [6538] and Klebsiella pneumoniae according to ATCC 4352, using 5 carrier wipes for each test. In each “Pass” result, greater than 99.9% of Staphylococcus aureus target organism was killed on all five carriers. Similarly, for each “Pass” result, greater than 99.9% of Klebsiella pneumoniae target organism was killed on all five carriers. The single ply low textured substrate with formula 3 was a “fail” because less than 99.9% of target organism Staphylococcus aureus were killed at 10 seconds contact time. This indicated that a two ply material at the 10 second contact time is superior for sanitization with respect to having at least a log 3 reduction in Staphylococcus aureus. A “Pass” is achieved so long as there is no more than 1 failure (growth) out of 10 assays. The results are sufficient to support a disinfection claim (e.g., a log 6 reduction) against Staphylococcus aureus for 10 second for a two ply substrate. The two ply substrate comprises a blend of hardwood and softwood fibers.

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

1. A pre-loaded sanitizing or disinfecting wipe comprising:
(a) a multi-layer substrate comprising two or more layers, each layer comprising greater than 70% by weight of pulp fibers, the two or more layers being adhered to one another with a water-resistant adhesive;
(b) a cleaning composition that is pre-loaded into the substrate of the wipe during manufacture, the cleaning composition comprising:
(i) about 0.1-2% by weight of a quaternary ammonium compound;
(ii) about 0.5-3% by weight of a glycol ether; and
(iii) about 90-99% water;
(c) wherein the water-resistant adhesive provides the wipe with a peel strength of at least 0.15 lb_{f}-in.

2. The wipe of claim 1, wherein the multi-layer substrate is a two layered substrate.

3. The wipe of claim 1, wherein the water-resistant adhesive comprises a vinyl acetate adhesive.

4. The wipe of claim 1, wherein the water-resistant adhesive provides the wipe with a peel strength from 0.15 lb_{f}-in to 0.5 lb_{f}-in.

5. The wipe of claim 1, wherein the water-resistant adhesive provides the wipe with a peel strength from 0.2 lb_{f}-in to 0.3 lb_{f}-in.

6. The wipe of claim 1, wherein the water-resistant adhesive is included in an amount of no more than 10 gsm.

7. The wipe of claim 6, wherein the substrate and water-resistant adhesive collectively have a basis weight of at least 35 gsm.

8. The wipe of claim 6, wherein the substrate and water-resistant adhesive collectively have a basis weight of 35 gsm to 55 gsm.

9. The wipe of claim 1, wherein the water-resistant adhesive is included in an amount from 3 gsm to 5 gsm.

10. The wipe of claim 6, wherein each layer of the multi-layer substrate has a basis weight of from 10 lbs/3000 ft² to 30 lbs/3000 ft².

11. The wipe of claim 1, wherein the water-resistant adhesive has a viscosity of less than 500 cps when applied.

12. The wipe of claim 1, wherein the water-resistant adhesive has a viscosity of greater than 200 cps when applied.

13. The wipe of claim 1, wherein the water-resistant adhesive has a viscosity from 250 cps to 450 cps when applied.

14. The wipe of claim 1, wherein the water-resistant adhesive is substantially void of polyvinyl alcohol.

15. The wipe of claim 1, wherein each layer of the multi-layer substrate is formed from short pulp fibers, having an average fiber length of less than 5 mm.

16. The wipe of claim 1, wherein each layer of the multi-layer substrate is formed from short pulp fibers, having an average fiber length of 1 mm to 3 mm.

17. The wipe of claim 1, wherein the substrate is substantially void of synthetic fibers, such that substantially all fibers of the substrate are pulp fibers.

18. The wipe of claim 1, wherein the sanitizing or disinfecting wipe releases the quaternary ammonium compound to a target surface and exhibits at least a 3-log reduction in Staphylococcus aureus population within 10 seconds to 5 minutes.

19. A pre-loaded sanitizing or disinfecting wipe comprising:
(a) a multi-layer substrate comprising two or more layers, each layer being formed from pulp fibers, wherein the multi-layer substrate is substantially void of synthetic fibers, such that substantially all fibers of the substrate are pulp fibers having an average length of less than 5 mm, the two or more layers being adhered to one another with a water-resistant adhesive included in an amount from 2 gsm to 10 gsm, so as to provide the wipe with a peel strength from 0.15 lb_{f}-in to 0.5 lb_{f}-in, the substrate and water-resistant adhesive collectively having a basis weight of 35 gsm to 55 gsm;
(b) a cleaning composition that is pre-loaded into the substrate of the wipe during manufacture, the cleaning composition comprising:
(i) 0.1-2% by weight of a quaternary ammonium compound; and
(ii) 90-99% water.

20. The wipe of claim 1, wherein the water-resistant adhesive comprises an ethylene vinyl acetate adhesive, the water-resistant adhesive being substantially void of polyvinyl alcohol.
